(19) United States
(12) Patent Application Publication
(10) Pub. No.: US 2014/0083687 A1
(43) Pub. Date: Mar. 27, 2014

(54) PRODUCTION IN FRACTURED SYSTEMS

(71) Applicant: Schlumberger Technology Corporation, Sugar Land, TX (US)

(72) Inventors: Bobby D. Poe, Houston, TX (US); William Keith Atwood, Katy, TX (US)

(73) Assignee: Schlumberger Technology Corporation, Sugar Land, TX (US)

(21) Appl. No.: 14/036,056

(22) Filed: Sep. 25, 2013

Related U.S. Application Data
(60) Provisional application No. 61/706,675, filed on Sep. 27, 2012.

(51) Int. Cl. E21B 49/00; G01V 9/02

(52) U.S. Cl. CPC E21B 49/00; G01V 9/02
USPC 166/250.1; 702/12; 73/152.18

(57) ABSTRACT

A method can include providing data for a field that includes fractures and a well; analyzing at least a portion of the data for times less than an interaction time; and outputting one or more values for a parameter that characterizes storage of a fluid in the field and one or more values for a parameter that characterizes transfer of the fluid in the field. Various other methods, devices, systems, etc., are also disclosed.

### RELATED APPLICATIONS

This application claims the benefit of U.S. Provisional Patent Application having Ser. No. 61/706,675, filed 27 Sep. 2012, which is incorporated by reference herein.

### BACKGROUND

Production of material from wells may be enhanced through fracturing. Techniques to characterize a fractured system may help improve production. Various techniques described herein pertain, for example, to characterizing fractured systems.

### SUMMARY

A method includes providing data for a field that includes fractures and a well; analyzing at least a portion of the data for times less than an interaction time; and outputting one or more values for a parameter that characterizes storage of a fluid in the field and one or more values for a parameter that characterizes transfer of the fluid in the field. A system for characterizing a field includes a well and hydraulic fractures can include a processor; memory accessible by the processor; and instructions modules stored in the memory and executable by the processor where the instructions modules include a production diaganostics instructions module associated with production of fluid from the field at least in part via the hydraulic fractures, a nonlinear regression instructions module, a near well variation determination instructions module, and a material balance analysis instructions module. Another method includes providing a fracture scheme; fracturing a well with multiple fractures according to the fracture scheme; providing data from the well; performing an analysis on the data where the performing includes analyzing at least a portion of the data for times less than an interaction time for the multiple fractures; and adjusting the fracture scheme based at least in part on the analysis of the data.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example of a schematic of a horizontal well intersecting multiple transverse vertical fractures;

FIG. 2 illustrates an example of production rate data of an example multiply-fractured horizontal gas well and a schematic of a horizontal well intersecting multiple transverse vertical fractures;

FIG. 3 illustrates an example of cumulative production history of example gas well;

FIG. 4 illustrates an example of wellhead and bottomhole pressure history of example gas well;

FIG. 5 illustrates an example of bilinear flow superposition time diagnostic analysis;

FIG. 6 illustrates an example of linear flow superposition time diagnostic analysis;

FIG. 7 illustrates an example of pseudoradial flow superposition time diagnostic analysis;

FIG. 8 illustrates an example of boundary-dominated flow superposition time diagnostic analysis;

FIG. 9 illustrates an example of rate-transient diagnostic analysis of example well performance;

FIG. 10 illustrates an example of match of cumulative gas production for the example multiply-fractured horizontal well;

FIG. 11 illustrates an example of effective permeability ratios computed from production data;

FIG. 12 illustrates an example of average reservoir pressure history permeability ratios computed from production data;

FIG. 13 illustrates an example of a system and an example of a geologic environment;

FIG. 14 illustrates an example of a field, an example of a timeline and an example of a method;

FIG. 15 illustrates an example of a method and an example of a system;

FIG. 16 illustrates an example of a method; and

FIG. 17 illustrates an example of a computing system that includes one or more networks, etc.

### DETAILED DESCRIPTION

The following description is not to be taken in a limiting sense, but rather is made merely for the purpose of describing the general principles of the implementations. The scope of the described implementations should be ascertained with reference to the issued claims.

As an example, a method may include modeling, characterizing, predicting, etc., a decline in production that may occur in a fractured system. As an example, a method can include performing a production decline analysis of wells intersecting fractures. In such an example, the wells may be horizontal wells intersecting multiple transverse vertical hydraulic fractures. As an example, a fractured system may include fractures in a low-permeability shale reservoir.

Various examples of production performance decline analysis techniques are described herein. As an example, such techniques may be applicable for characterization of well and reservoir properties of low permeability fractured shale gas or oil reservoirs, for example, such as those completed with horizontal wells intersected by multiple, transverse, finite-conductivity, vertical fractures. As an example, the term “horizontal well” may refer to a well that includes a portion that is deviated from vertical, for example, to target a subterranean formation such as, for example, a shale formation. As an example, the term “vertical fracture” may refer to a fracture that may be formed using a fracturing process that includes, at least in part, passing fluid through a “horizontal well”, for example, such that a fracture or fractures are formed that extend from the well. Such a fracture or fractures may be referred to as, for example, artificial fractures, which may include a hydraulic fracture or hydraulic fractures.

An artificial fracture may be made, for example, by injecting fluid into a well to increase pressure in the well beyond a level sufficient to cause fracture of a surrounding formation or formations. In such an example, an artificial fracture is in fluid communication with the well. Thus, an artificial fracture may generally be viewed as being part of a network that includes a well. As to chemical processes such as acidizing, such a process may be applied to a natural fracture (e.g., artificial enhancement of an existing fracture) or an artificial fracture (e.g., a hydraulic fracture). Acidizing may be considered to be a stimulation operation in which acid (e.g., hydrochloric acid), is injected into a formation (e.g., carbonate formation) such that the acid etches fracture faces to form conductive channels. As an example, hydrochloric acid may be introduced into a fracture in a limestone formation to react with the limestone to form calcium chloride, carbon dioxide and water. As another example, consider a dolomite formation where magnesium chloride is also formed. Acids other than hydrochloric acid may be used (e.g., hydrofluoric acid, etc.). As an example, a mixture of acids may be used.

As to pressure fracturing, pressure to fracture a formation may be estimated based in part on a fracture gradient for the formation (e.g., kPa/m or psi/foot). As an example, techniques to make fractures may involve combustion or explosion (e.g., combustible gases, explosives, etc.). As to hydraulic fractures, injected fluid (e.g., water, other fluid, mixture of fluids, etc.) may be used to open and extend a fracture from a well and may be used to transport a proppant throughout a fracture. A proppant may include sand, ceramic or other particles that can hold fractures open, at least to some extent, after a hydraulic fracturing treatment (e.g., to preserve paths for flow, whether, for example, from a well to a reservoir or vice versa).

Artificial fractures may be oriented in any of a variety of directions, which may be, at least to some extent, controllable (e.g., based on wellbore direction, size and location; based on pressure and pressure gradient with respect to time; based on injected material; based on use of a proppant; based on existing stress; etc.). As an example, a vertical artificial fracture may be an artificial fracture oriented in a direction that may include a vertical direction component, for example, that extends from a deviated well (e.g., a well that includes a horizontal direction component).

Hydraulic fracturing may be particularly useful for production of natural gas, including so-called unconventional natural gas. A large percentage of worldwide reserves of unconventional natural gas may be categorized as undeveloped resources. Reasons for lack of production from such reserves can include an industry focus on producing gas from conventional reserves and difficulty of producing gas from unconventional gas reserves. Unconventional gas reserves may be characterized by low permeability where gas has difficulty flowing into wells without some type of assistive efforts. For example, one way to assist gas flow from an unconventional reservoir can involve hydraulic fracturing to increase overall productivity of the reservoir.

As an example, a technique may be applied to characterize physical properties of a reservoir within a reasonable amount of time. Such a technique may provide insight as to production performance of wells associated with a reservoir through an evaluation that includes a transient production decline analysis, for example, to determine reservoir properties (e.g., permeability, estimated stimulated reservoir volume (SRV), etc.) and well completion effectiveness (e.g., effective fracture half-length, conductivity, etc.).

As an example, production decline analyses can include graphical production decline diagnostic analyses and optionally history matching with a multiple-transverse fracture horizontal well transient solution using one or more regression analysis techniques. As an example, specialized diagnostic analyses may be employed for intermediate flow regimes that may be exhibited in a transient performance of multiply-fractured horizontal wells, for example, to obtain estimates of or limits on a reservoir and well properties (e.g., optionally refined using nonlinear minimization techniques in a history matching analysis).

Data from a field trial example is presented herein that demonstrates application of various production performance analysis procedures. Evaluation of reservoir properties and well completion effectiveness of multiply-fractured horizontal wells in fractured shale reservoirs using transient production performance of such wells may be beneficial. For example, a combined production diagnostic—history matching analysis can provide for characterizing properties and production performance of multiple-transverse-fractured horizontal wells in low permeability shale reservoirs.

### Example

### Trilinear Approach

As an example, a model may include one or more features for representing one or more wells and one or more factures associated with a reservoir (e.g., a sand reservoir, a shale reservoir, a sand and shale reservoir, etc.). As an exmalpe, such a model may provide for analysis of low-permeability (e.g., micro- and nano-Darcy range) fractured shale reservoirs, for example, that have been completed with horizontal wells that intersect multiple transverse vertical fractures. As an example, an approximate pressure-transient well performance model may be a so-called “trilinear model” (e.g., due to three regions of idealized linear flow). A trilinear model can include a first region of idealized linear flow in a reservoir region within a length of fractures. Within this region, linear flow may be assumed to exist in which the fluid flow is normal to a plane of one or more vertical fractures. In such an example, reservoir volume may be defined by lengths of vertical fractures, formation thickness, number of vertical fractures, and spacing between adjacent fractures (e.g., a stimulated reservoir volume (SRV)).

As an example, a second region in a trilinear model may be for idealized linear flow within a fracture and a third region may be for idealized linear flow one or more reservoir regions beyond a length of vertical fracture(s). In low permeability reservoirs (e.g., such as fractured shale gas and oil reservoirs), the contribution to a well's production from a reservoir region that lies beyond the SRV may be negligible in practice.

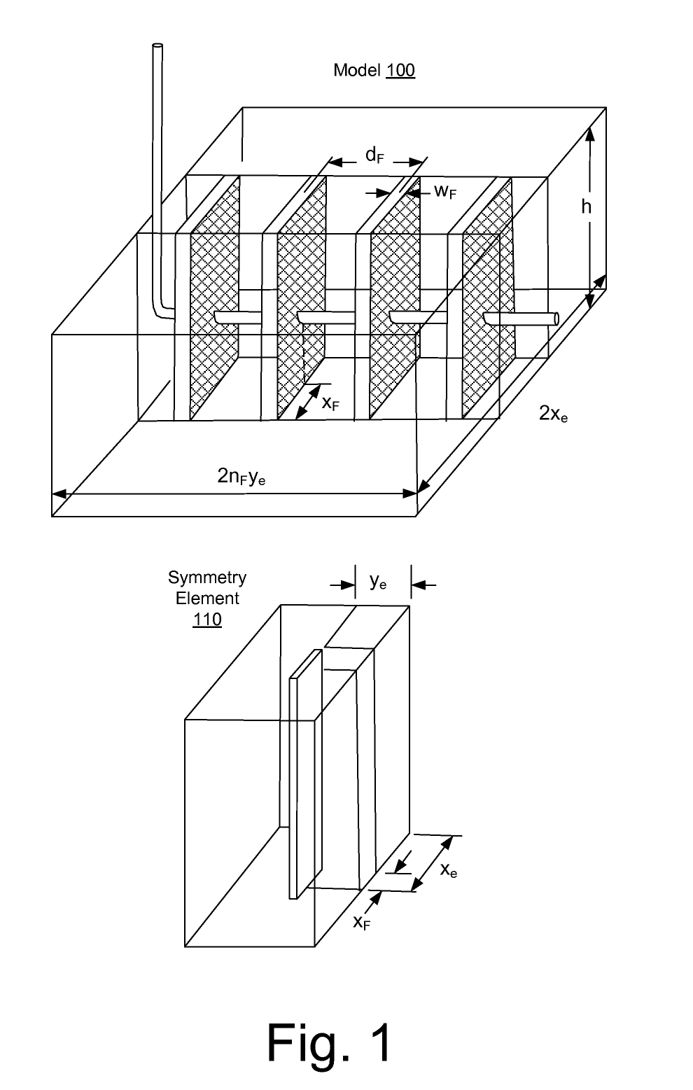

FIG. 1 shows an illustration depicting an idealized model 100 of a horizontal well intersected by multiple transverse vertical fractures, for example, corresponding to a trilinear model. FIG. 1 also shows a symmetry element 110, which may be used for purposes of modeling. In a solution to a trilinear model, dimensions and properties of each of the vertical fractures may be assumed to be identical, for example, which may permit evaluation of a single fracture and associated drainage area. Such a solution may be extended to an entire horizontal well and multiple, transverse, vertical fractures system, for example, by use of symmetry. In such an example, an actual horizontal well may be deviated from vertical and include a horizontal direction component and an actual vertical fracture may include a vertical direction component. In other words, an actual horizontal well need not be strictly horizontal (e.g., with respect to a surface of the Earth) and an actual vertical fracture need not be strictly vertical (e.g., with respect to a surface of the Earth).

As an example, a trilinear pressure-transient approach may be implemented for development of flow regime specific diagnostic analyses and a more general nonlinear inversion for the analysis of the production performance of a horizontal well intersected by multiple transverse vertical fractures in a very low permeability fractured shale reservoir.

### Diagnostic Analyses

As an example, flow regimes that may be exhibited in a pressure or rate-transient behavior of a horizontal well intersected by multiple, transverse, vertical fractures may correspond to early, intermediate, and late time behavior of a well's performance. In such an example, early-time pressure-transient behavior of a multiply-fractured horizontal well may be dominated by well storage. While analysis of transient performance of such a flow regime may not be most useful in production performance analyses for the determination of well completion effectiveness and reservoir properties, intermediate flow regime analyses may provide information that can characterize well and reservoir properties from production performance.

As an example, specialized diagnostic analyses may be developed for specific intermediate-time flow regimes that may be exhibited in a well's production performance. For example, these may include bilinear and linear flow regimes, as well as possibly other less well known transition flow regime behaviors. As an example, pressure-transient behavior of a well during a bilinear flow regime may vary directly as a function of the quarter root of time, while pressure-transient behavior of a well exhibiting linear flow may vary proportionately with the square root of time.

As characterization of well completion effectiveness and reservoir intrinsic properties may be of interest, characterization that can be performed to reduce level of uncertainty and lack of uniqueness in an inverse analysis results may be beneficial. As an example, a method may include an initial determination as to type of transient behavior that is being exhibited in production performance of a well. For example, such a process may be accomplished by preparing diagnostic analysis graphs of rate-normalized drawdown of a system as a function of applicable superposition time functions for flow regimes under consideration. For example, when bilinear or linear flow regimes are being exhibited in a well's production performance, a linear relationship may be exhibited in both pressure and derivative function response in which the derivative function has an intercept value equal to 0 (e.g., where a derivative function line passes through the origin). As an example, such a condition may be true for each of two specialized flow regime analyses.

For example, a first-look diagnostic analysis of a multiply-fractured horizontal well in a low permeability gas reservoir may include plotting flow rate normalized pseudopressure drop corresponding to a well's production data against appropriate superposition time functions for bilinear, linear, and pseudoradial flow regimes. These relationships may be expressed mathematically as in Eqs. 1, 2, and 3 for bilinear, linear, and pseudoradial flow diagnostics, respectively.

$$\begin{matrix}\frac{{P}_{p} ( {P}_{i} ) - {P}_{p} ( {P}_{wf} ( {t}_{n} ) )}{{q}_{g} ( {t}_{n} )} vs . f ( {t}_{n}^{1 \text{/} 4} ) = {( {t}_{n} - {t}_{n - 1} )}^{1 \text{/} 4} + {\sum }_{i = 1}^{n - 1} \frac{{q}_{g} ( {t}_{i} )}{{q}_{g} ( {t}_{n} )} [ {( {t}_{n} - {t}_{i - 1} )}^{1 \text{/} 4} - {( {t}_{n} - {t}_{i} )}^{1 / 4} ] & ( 1 ) \\ \frac{{P}_{p} ( {P}_{i} ) - {P}_{p} ( {P}_{wf} ( {t}_{n} ) )}{{q}_{g} ( {t}_{n} )} vs . f ( {t}_{n}^{1 \text{/} 2} ) = {( {t}_{n} - {t}_{n - 1} )}^{1 \text{/} 2} + {\sum }_{i = 1}^{n - 1} \frac{{q}_{g} ( {t}_{i} )}{{q}_{g} ( {t}_{n} )} [ {( {t}_{n} - {t}_{i - 1} )}^{1 \text{/} 2} - {( {t}_{n} - {t}_{i} )}^{1 / 2} ] & ( 2 ) \\ \frac{{P}_{p} ( {P}_{i} ) - {P}_{p} ( {P}_{wf} ( {t}_{n} ) )}{{q}_{g} ( {t}_{n} )} vs . f ( {t}_{n} ) = log ( {t}_{n} - {t}_{n - 1} ) + {\sum }_{i = 1}^{n - 1} \frac{{q}_{g} ( {t}_{i} )}{{q}_{g} ( {t}_{n} )} [ log ( {t}_{n} - {t}_{i - 1} ) - log ( {t}_{n} - {t}_{i} ) ] & ( 3 )\end{matrix}$$

As an example, one or more graphical plotting functions for production analyses of fractured shale reservoirs in geographical areas that produce predominantly hydrocarbon liquids may be developed that may be analogous to Eqs. 1-3, for example, expressed in terms of the flow rate normalized pressure drawdown:

$$( \frac{{P}_{i} - {P}_{wf} ( {t}_{n} )}{q} ) .$$

The superposition time relationships given in Eqs. 1-3 for gas reservoir analyses have been expressed in terms of time instead of pseudotime, which, for example, has been found to be acceptable and also appropriate in practice for the analysis of infinite-acting reservoir analyses. Under boundary-dominated flow conditions, use of pseudotime integral transformation in these superposition time functions may be warranted.

Pressure-transient behavior (e.g., based on well total flow rate) during bilinear flow for a multiply-fractured horizontal well (e.g., a well with a substantially horizontal portion) in an approximated single porosity system may be given by Eq. 4. Such a relationship may also be applicable for characterizing pressure-transient behavior of pseudosteady state and transient interporosity flow conditions in dual porosity reservoir systems (e.g., systems approximated using a dual porosity approach).

$${n}_{f} {P}_{wD} = \frac{π {t}_{D}^{1 \text{/} 4}}{\sqrt{2 {C}_{fD}} Γ ( \frac{5}{4} )} + {S}_{c} \qquad ( 4 )$$

Other bilinear flow regime pressure-transient behavior approximations have also been developed for specific values (or ranges of values) of the dual porosity reservoir parameters (co and X). Various examples of equations are given below for representing relationships for pseudosteady state interporosity flow (Eq. 5) and for transient interporosity flow (Eqs. 6 and 7). Note that the pressure derivative function, written generally as:

$$( t \frac{\partial Δ P}{\partial t} ) ,$$

may be used in pressure-transient well test analyses also varies with respect to the quarter root of time.

$$\begin{matrix}{n}_{f} {P}_{wD} = \frac{π {t}_{D}^{1 / 4}}{\sqrt{2 {C}_{fD}} Γ ( \frac{5}{4} ) ω} + {S}_{c} & ( 5 ) \\ {n}_{f} {P}_{wD} = \frac{π {t}_{D}^{1 / 4}}{\sqrt{2 {C}_{fD}} Γ ( \frac{5}{4} ) ( 1 + ω )} + {S}_{c} & ( 6 ) \\ {n}_{f} {P}_{wD} = \frac{π}{2} {( \frac{3}{ω λ} )}^{1 \text{/} 4} \frac{{t}_{D}^{1 \text{/} 4}}{Γ ( \frac{5}{4} )} + \frac{π}{3 {C}_{fD}} + {S}_{c} & ( 7 )\end{matrix}$$

A pressure-transient flow approximation that describes transient behavior of a multiply-fractured horizontal well in a single porosity reservoir that exhibits linear flow may be given by Eq. 8. Such a relationship may also be applicable for both pseudosteady state and transient interporosity flow conditions in dual porosity reservoir systems.

$${n}_{f} {P}_{wD} = \sqrt{π {t}_{D}} + \frac{π}{3 {C}_{fD}} + {S}_{c} \qquad ( 8 )$$

As an example, one or more other approximations of linear flow pressure-transient behavior of multiply-fractured horizontal wells completed in dual porosity reservoirs assuming specific ranges of the dual porosity reservoir parameter values may be given, for example, as in Eq. 9 for pseudosteady state interporosity flow, and by Eqs. 10 and 11 for transient interporosity flow conditions, respectively. In a manner akin to that discussed regarding the pressure derivative behavior for bilinear flow, pressure derivative function during linear flow may have a slope that may be approximately equivalent to the pressure-transient behavior (e.g., as it may vary with respect to the square root of time).

$$\begin{matrix}{n}_{f} {P}_{wD} = \sqrt{\frac{π {t}_{D}}{ω}} + \frac{π}{3 {C}_{fD}} + {S}_{c} & ( 9 ) \\ {n}_{f} {P}_{wD} = \sqrt{\frac{π {t}_{D}}{1 + ω}} + \frac{π}{3 {C}_{fD}} + {S}_{c} & ( 10 ) \\ {n}_{f} {P}_{wD} = \sqrt{\frac{3}{ω λ}} \frac{2 {X}_{f} \sqrt{π {t}_{D}}}{{d}_{f}} + \frac{π {d}_{f}}{12 {X}_{f}} + \frac{π}{3 {C}_{fD}} + {S}_{c} & ( 11 )\end{matrix}$$

The corresponding definitions of the dimensionless variables given in these expressions are given by Eqs. 12, 13, and 14 for the dimensionless time, pressure, and fracture conductivity, respectively. The associated definitions of the pseudopressure and pseudotime functions for use in gas reservoir analyses are given in Eqs. 15 and 16, and the converging flow steady state skin effect correlation for flow to a horizontal wellbore within the vertical fracture may be, for example, as provided by Eq. 17.

$$\begin{matrix}{t}_{D} = \frac{0.0002637 k {t}_{a} ( t )}{φ {X}_{f}^{2}} & ( 12 ) \\ {P}_{wD} = \frac{kh {T}_{sc} ( {P}_{p} ( {P}_{i} ) - {P}_{p} ( {P}_{wf} ( t ) ) )}{50300 {P}_{sc} T} & ( 13 ) \\ {C}_{fD} = \frac{{k}_{f} w}{k {X}_{f}} & ( 14 ) \\ {P}_{p} ( P ) = 2 {\int }_{{P}_{b}}^{P} \frac{{P}^{′}}{μ Z} d {P}^{′} & ( 15 ) \\ {t}_{a} ( t ) = {\int }_{0}^{t} \frac{d t}{{μ}_{g} {c}_{t}} = \frac{t}{\overline{{μ}_{g} {c}_{t}}} \approx {\int }_{{P}_{i}}^{{P}_{r} ( t )} \frac{( \frac{\partial t}{\partial P} )}{{μ}_{g} {c}_{t}} d P & ( 16 ) \\ {S}_{c} = \frac{kh}{{k}_{f} w} [ ln ( \frac{h}{2 {r}_{w}} ) - \frac{π}{2} ] & ( 17 )\end{matrix}$$

For evaluation of pressure-transient response of multiply-fractured horizontal wells in oil reservoirs, corresponding definitions of dimensionless time and wellbore pressure may be given, for example, as in Eqs. 18 and 19. In addition, classical definitions of a dual porosity reservoir storativity ratio (ω) and a crossflow parameter (X) may be as given, for example, as in Eqs. 20 and 21.

$$\begin{matrix}{t}_{D} = \frac{0.0002637 kt}{φμ {c}_{t} {X}_{f}^{2}} & ( 18 ) \\ {P}_{wD} = \frac{kh ( {P}_{i} - {P}_{wf} ( t ) )}{141.2 q μ B} & ( 19 ) \\ ω = \frac{{( φ {c}_{t} )}_{f}}{{( φ {c}_{t} )}_{f} + {( φ {c}_{t} )}_{m}} & ( 20 ) \\ λ = σ {X}_{f}^{2} \frac{{k}_{m}}{{k}_{f}} & ( 21 )\end{matrix}$$

Pressure-transient behavior of multiply-fractured horizontal wells during other flow regimes, such as, for example, pseudoradial or pseudosteady state flow, may also be used to develop specialized diagnostics for evaluating some or all of unknown reservoir intrinsic properties and well completion effectiveness. However, as an example, as flow regimes that are prominently exhibited in early and intermediate-time production behavior of multiply-fractured horizontal wells in very low permeability fractured shale reservoirs may be approximately linear flow and occasionally approximately bilinear flow. Examples of such flow regime analyses are further described below.

### Example

### Bilinear Flow Diagnostic Analysis of Gas Reservoir Performance

For bilinear flow of a multiply-fractured horizontal well in a gas reservoir, a graph of the flow rate normalized pseudopressure drawdown versus the bilinear flow superposition time function may yield a linear graph whose derivative function is also linear, passes through the origin of the graphical analysis, and is parallel to the pressure-transient response. For single porosity gas reservoirs (and some dual porosity systems), the appropriate interpretation analysis is developed from Eqs. 4 and 12-17. In this case, the fracture conductivity can be directly computed from the pressure and derivative functions, as given in Eq. 22. The direct solution procedure for the bilinear flow regime analysis is possible in this type of well completion because of the availability of the additional relationship (e.g., converging flow steady state skin effect) in multiply-fractured horizontal wells while it may not be applicable for fully penetrating vertical wells intersecting a finite-conductivity vertical fracture, for which the slope of the bilinear flow analysis may provide a value of the product of the reservoir effective permeability and the square of the fracture conductivity.

$${k}_{f} w = \frac{50300 {P}_{sc} T [ ln ( \frac{h}{2 {r}_{w}} ) - \frac{π}{2} ]}{{n}_{f} {T}_{sc} [ \frac{Δ {P}_{p}}{{q}_{g}} - 4 t \frac{\partial ( \frac{Δ {P}_{p}}{{q}_{g}} )}{\partial t} ]} = \frac{50300 {P}_{sc} T [ ln ( \frac{h}{2 {r}_{w}} ) - \frac{π}{2} ]}{{n}_{f} {T}_{sc} [ {a}_{1} - 3 {a}_{2} f ( {t}^{1 / 4} ) ]} \qquad ( 22 )$$

The second expression given for determining fracture conductivity given in Eq. 22 is derived from a linear fit of pressure transient response:

$$[ \frac{Δ {P}_{p}}{{q}_{g}} = {a}_{1} + {a}_{2} f ( {t}^{\frac{1}{4}} ) ]$$

and the fact that the derivative function passes through the origin of the graphical analysis. With this result, the reservoir effective permeability can be also determined directly with the expression given in Eq. 23. As an example, a method may then determine converging flow steady state skin effect using Eq. 17.

$$k = {\frac{2.3787 \times {10}^{14}}{φ {\overline{{μ}_{g} {c}_{t}} [ {k}_{f} w ]}^{2}} [ \frac{{P}_{sc} T f ( {t}^{1 / 4} )}{{n}_{f} h {T}_{sc} t \frac{\partial ( \frac{Δ {P}_{p}}{{q}_{g}} )}{\partial t}} ]}^{4} = {\frac{2.3787 \times {10}^{14}}{φ {\overline{{μ}_{g} {c}_{t}} [ {k}_{f} w ]}^{2}} [ \frac{{P}_{sc} T}{{n}_{f} h {T}_{sc} {a}_{2}} ]}^{4} \qquad ( 23 )$$

The corresponding analyses of the bilinear flow performance using either of the two bilinear flow analysis models given by Eqs. 5 and 6 (in place of Eq. 4) also result in the same solution for the fracture conductivity relationship given in Eq. 22. The differences that exist for the pressure-transient solutions of Eqs. 5 and 6 are found in the resulting expressions for determining the products of the reservoir effective permeability and functions of the dual porosity reservoir storativity ratio (ω), given in Eqs. 24 and 25 for the pressure transient solutions of Eqs. 5 and 6, respectively. These solutions constitute a second and third bilinear flow analysis interpretive model for dual porosity systems in gas reservoirs with multiply-fractured horizontal wells.

$$\begin{matrix}k ω = {\frac{2.3787 \times {10}^{14}}{φ {\overline{{μ}_{g} {c}_{t} } [ {k}_{f} w ]}^{2}} [ \frac{{P}_{sc} T f ( {t}^{1 / 4} )}{{n}_{f} h {T}_{sc} t \frac{\partial ( \frac{Δ {P}_{p}}{{q}_{g}} )}{\partial t}} ]}^{4} = {\frac{2.3787 \times {10}^{14}}{φ {\overline{{μ}_{g} {c}_{t} } [ {k}_{f} w ]}^{2}} [ \frac{{P}_{sc} T}{{n}_{f} h {T}_{sc} {a}_{2}} ]}^{4} & ( 24 ) \\ k ( 1 + ω ) = {\frac{2.3787 \times {10}^{14}}{φ {\overline{{μ}_{g} {c}_{t}} [ {k}_{f} w ]}^{2}} [ \frac{{P}_{sc} Tf ( {t}^{1 / 4} )}{{n}_{f} {hT}_{sc} t \frac{\partial ( \frac{Δ {P}_{p}}{{q}_{g}} )}{\partial t}} ]}^{4} = {\frac{2.3787 \times {10}^{14}}{φ {\overline{{μ}_{g} {c}_{t}} [ {k}_{f} w ]}^{2}} [ \frac{{P}_{sc} T}{{n}_{f} h {T}_{sc} {a}_{2}} ]}^{4} & ( 25 )\end{matrix}$$

A fourth bilinear flow analysis can be developed using the pressure-transient solution given by Eq. 7 that directly provides a means of determining the product of the reservoir effective permeability cubed, effective fracture half-length squared, and the dual porosity reservoir parameters ω and λ. This result may be given as in Eq. 26.

$$ωλ {k}^{3} {X}_{f}^{2} = {\frac{1.784 \times {10}^{14}}{φ \overline{{μ}_{g} {c}_{t}}} [ \frac{{P}_{sc} Tf ( {t}^{1 / 4} )}{{n}_{f} {hT}_{sc} t \frac{\partial ( \frac{Δ {P}_{p}}{{q}_{g}} )}{\partial t}} ]}^{4} = {\frac{1.784 \times {10}^{14}}{φ \overline{{μ}_{g} {c}_{t}}} [ \frac{{P}_{sc} T}{{n}_{f} {hT}_{sc} {a}_{2}} ]}^{4} \qquad ( 26 )$$

A direct solution procedure for the remaining unknown reservoir and fracture properties in this case is not readily provided for the bilinear flow transient solution. Rather, a range of dimensionless fracture conductivity values may be considered and the corresponding minimum and maximum possible reservoir effective permeability, fracture conductivity, and fracture half-length may be determined. In this evaluation methodology, it is noted that expressions for the fracture conductivity may be derived that are defined as in Eq. 27. As an example, a range of dimensionless fracture conductivities between 0.1 and 30 have been found in practice to be suitable for various fractured shale reservoir analyses.

$${k}_{f} w = {C}_{fD} {\{ \frac{[ ωλ {k}^{3} {X}_{f}^{2} ] {X}_{f}}{ωλ} \}}^{1 / 3} = \frac{\frac{π {X}_{f}}{3} + h [ ln ( \frac{h}{2 {r}_{w}} ) - \frac{π}{2} ]}{\frac{{n}_{f} h {T}_{sc} ( \frac{Δ {P}_{p}}{{q}_{g}} )}{50300 {P}_{sc} T} - \frac{0.29064 f ( {t}^{1 / 4} )}{{[ ωλ {k}^{3} {X}_{f}^{2} ]}^{1 / 4}}} \qquad ( 27 )$$

Once the solution of Eq. 27 is obtained for the value of fracture half-length that satisfies the fracture conductivity relationships, the fracture conductivity may then be evaluated with either expression given in Eq. 27. Using the value of fracture half-length derived from the solution of Eq. 27, the corresponding reservoir effective permeability is obtained with Eq. 28.

$$k = {\{ \frac{[ ωλ {k}^{3} {X}_{f}^{2} ]}{ωλ {X}_{f}^{2}} \}}^{1 / 3} \qquad ( 28 )$$

As an example, corresponding fracture half-length may be determined using Eq. 29.

$${X}_{f} = \frac{{k}_{f} w}{{c}_{fD} k} \qquad ( 29 )$$

### Example

### Bilinear Flow Diagnostic Analysis of Oil Reservoir Performance

Bilinear flow analysis relationships for oil reservoirs may also be developed along lines such as those given for gas reservoir analyses. As an example, fracture conductivity may be determined from the bilinear flow behavior of a single porosity oil reservoir (e.g., and some dual porosity reservoirs) from the solution of Eqs. 4, 14, and 17-19. A Cartesian graphical analysis of the flow rate normalized pressure drawdown and corresponding derivative function plotted against the bilinear flow superposition time function provides a means of determining the fracture conductivity. A linear curve fit of this intermediate-time data of the form:

$$[ \frac{Δ P}{qB} = {a}_{1} + {a}_{2} f ( {t}^{\frac{1}{4}} ) ]$$

may be used to evaluate the bilinear flow relationship for the determination of the fracture conductivity, with the substitution given in the right half of Eq. 30.

$${k}_{f} w = \frac{141.2 μ [ ln ( \frac{h}{2 {r}_{w}} ) - \frac{π}{2} ]}{{n}_{f} [ \frac{Δ P}{qB} - 4 t \frac{\partial ( \frac{Δ P}{qB} )}{\partial t} ]} = \frac{141.2 μ [ ln ( \frac{h}{2 {r}_{w}} ) - \frac{π}{2} ]}{{n}_{f} [ {a}_{1} - 3 {a}_{2} f ( {t}^{1 / 4} ) ]} \qquad ( 30 )$$

The corresponding relationship for determining the effective permeability in a single porosity oil reservoir analysis from the bilinear flow transient performance may be given by Eq. 31.

$$k = {\frac{14774 {μ}^{3}}{φ {{c}_{t} [ {k}_{f} w ]}^{2}} [ \frac{f ( {t}^{1 / 4} )}{{n}_{f} ht \frac{\partial ( \frac{Δ P}{qB} )}{\partial t}} ]}^{4} = {\frac{14774 {μ}^{3}}{φ {{c}_{t} [ {k}_{f} w ]}^{2}} [ \frac{1}{{n}_{f} {ha}_{2}} ]}^{4} \qquad ( 31 )$$

The bilinear flow pressure-transient solutions given by Eqs. 5 and 6 result in a relationship for the fracture conductivity such as that given in Eq. 30 for the single porosity reservoir analysis. However, expressions for product of the reservoir effective permeability and function of the dual porosity reservoir storativity ratio that correspond to the pressure-transient solutions of Eqs. 5 and 6 result in second and third dual porosity reservoir interpretive models for bilinear flow of multiply-fractured horizontal wells in oil reservoirs given with Eqs. 32 and 33, respectively.

$$\begin{matrix} k ω = {\frac{14774 {μ}^{3}}{φ {{c}_{t} [ {k}_{f} w ]}^{2}} [ \frac{f ( {t}^{1 / 4} )}{{n}_{f} ht \frac{\partial ( \frac{Δ P}{qB} )}{\partial t}} ]}^{4} = {\frac{14774 {μ}^{3}}{φ {{c}_{t} [ {k}_{f} w ]}^{2}} [ \frac{1}{{n}_{f} {ha}_{2}} ]}^{4} & ( 32 ) \\ k ( 1 + ω ) = {\frac{14774 {μ}^{3}}{φ {{c}_{t} [ {k}_{f} w ]}^{2}} [ \frac{f ( {t}^{1 / 4} )}{{n}_{f} ht \frac{\partial ( \frac{Δ P}{qB} )}{\partial t}} ]}^{4} = {\frac{14774 {μ}^{3}}{φ {c}_{t} [ {k}_{f} w ]} [ \frac{1}{{n}_{f} {ha}_{2}} ]}^{4} & ( 33 )\end{matrix}$$

### Example

### Linear Flow Diagnostic Analysis of Gas Reservoir Performance

Specialized diagnostic analyses can also be developed for analysis of linear flow behavior of a multiply-fractured horizontal well in a gas reservoir. A graph of the flow rate normalized pseudopressure drawdown versus the linear flow superposition time function can yield a linear pressure-transient relationship whose derivative function has a slope as for the pressure function, for example, except that it passes through the origin (e.g., has an intercept of 0). A linear flow analysis interpretation model for a single porosity gas reservoir (e.g., and some dual porosity systems) may be developed using Eqs. 8 and 12-17. Coordinates of a point on the pressure derivative curve during the linear flow period can result in a value of the product of the reservoir effective permeability to gas and the square of the effective half-length. Substitution into the right half of Eq. 34 for the fitted linear relationship of the pressure curve may be defined by:

$$[ \frac{Δ {P}_{p}}{{q}_{g}} = {a}_{1} + {a}_{2} f ( {t}^{\frac{1}{2}} ) ] \\ {kX}_{f}^{2} = {\frac{523954}{φ \overline{{μ}_{g} {c}_{t}}} [ \frac{{P}_{sc} Tf ( {t}^{1 / 2} )}{{n}_{f} {hT}_{sc} t \frac{\partial ( \frac{Δ {P}_{p}}{{q}_{g}} )}{\partial t}} ]}^{2} = {\frac{523954}{φ \overline{{μ}_{g} {c}_{t}}} [ \frac{{P}_{sc} T}{{n}_{f} {hT}_{sc} {a}_{2}} ]}^{2} \qquad ( 34 )$$

Evaluation of individual unknown parameters of a problem (k, X_{f}, and k_{fW}) may be determined for a range of dimensionless fracture conductivity values. Typically values of dimensionless fracture conductivity between 80 and 500 have been found to be adequate for evaluation of the upper and lower limits of these variables. Note that duration of a linear flow regime may be a function of dimensionless fracture conductivity. As an example, start of a linear flow regime of a finite-conductivity vertical fracture may be given by Eq. 35 and, for example, end of the linear flow regime may be given by Eq. 36. Therefore, in such an example, for dimensionless fracture conductivities less than about 80, one may not necessarily expect to observe any appreciable amount of linear flow behavior exhibited in a well's performance.

$$\begin{matrix}{t}_{Dslf} = \frac{100}{{c}_{fD}^{2}} & ( 35 ) \\ {t}_{Delf} = 0.016 & ( 36 )\end{matrix}$$

Expressions for fracture half-length in terms of assumed values of dimensionless fracture conductivity may be obtained from the product of the reservoir effective permeability and fracture half-length squared obtained with Eq. 34 and the relationships given in Eqs. 8 and 12-17. Resulting relationships are presented in Eq. 37 and are resolved for the unknown fracture conductivity (k_{fW}). Once the unknown fracture conductivity has been determined, as an example, fracture half-length may then be computed using either expression of Eq. 37a or 37b.

$$\begin{matrix}{X}_{f} = \frac{{n}_{f} {T}_{sc} h {k}_{f} w}{52674 {P}_{sc} T} [ \frac{Δ {P}_{p}}{{q}_{g}} - 2 t \frac{\partial ( \frac{Δ {P}_{p}}{{q}_{g}} )}{\partial t} ] - \frac{3 h}{π} [ ln ( \frac{h}{2 {r}_{w}} ) - \frac{π}{2} ] = {\frac{523954 {C}_{fD}}{{k}_{f} w φ \overline{{μ}_{g} {c}_{t}}} [ \frac{{P}_{sc} Tf ( {t}^{1 \text{/} 2} )}{{n}_{f} {T}_{sc} ht \frac{\partial ( \frac{Δ {P}_{p}}{{q}_{g}} )}{\partial t}} ]}^{2} & ( 37 a ) \\ {X}_{f} = \frac{{n}_{f} {T}_{sc} h {k}_{f} w}{52674 {P}_{sc} T} [ {a}_{1} - {a}_{2} f ( {t}^{1 / 2} ) ] - \frac{3 h}{π} [ ln ( \frac{h}{2 {r}_{w}} ) - \frac{π}{2} ] = {\frac{523954 {C}_{fD}}{{k}_{f} w φ \overline{{μ}_{g} {c}_{t}}} [ \frac{{P}_{sc} T}{{n}_{f} {T}_{sc} h {a}_{2}} ]}^{2} & ( 37 b )\end{matrix}$$

The corresponding value of the reservoir effective permeability may be evaluated using Eq. 38.

$$k = \frac{{( \frac{{k}_{f} w}{{c}_{fD}} )}^{2}}{[ {kX}_{f}^{2} ]} \qquad ( 38 )$$

Pressure-transient solutions given by Eqs. 9 and 10 for the linear flow regime may result in expressions for the product of the reservoir effective permeability, fracture half-length squared, and a function of the dual porosity reservoir storativity ratio, for example, as given by Eqs. 39 and 40, respectively. These solutions correspond to the second and third interpretive models for the analysis of the linear flow behavior of a multiply-fractured horizontal well that is completed in a fractured shale gas reservoir that behaves as a dual porosity system.

$$\begin{matrix}ω {kX}_{f}^{2} = {\frac{523954}{φ \overline{{μ}_{g} {c}_{t}}} [ \frac{{P}_{sc} Tf ( {t}^{1 \text{/} 2} )}{{n}_{f} {hT}_{sc} t \frac{\partial ( \frac{Δ {P}_{p}}{{q}_{g}} )}{\partial t}} ]}^{2} = {\frac{523954}{φ \overline{{μ}_{g} {c}_{t}}} [ \frac{{P}_{sc} T}{{n}_{f} {hT}_{sc} {a}_{2}} ]}^{2} & ( 39 ) \\ ( 1 + ω ) {kX}_{f}^{2} = {\frac{523954}{φ \overline{{μ}_{g} {c}_{t}}} [ \frac{{P}_{sc} Tf ( {t}^{1 \text{/} 2} )}{{n}_{f} {hT}_{sc} t \frac{\partial ( \frac{Δ {P}_{p}}{{q}_{g}} )}{\partial t}} ]}^{2} = {\frac{523954}{φ \overline{{μ}_{g} {c}_{t}}} [ \frac{{P}_{sc} T}{{n}_{f} {hT}_{sc} {a}_{2}} ]}^{2} & ( 40 )\end{matrix}$$

Individual well and reservoir properties may be once again resolved for a range of assumed values of the dimensionless fracture conductivity. The fracture half-length relationships that correspond to the pressure-transient solutions of Eqs. 10 and 11 may be given by Eqs. 41 and 42, respectively. Once the fracture conductivity is obtained that satisfies the appropriate relationships given in Eqs. 41 or 42, the fracture half-length may then be determined using the appropriate expressions given by Eqs. 41 (a or b) and 42 (a or b). The first (a) relationship given in Eqs. 41 and 42 is expressed in the form of the pressure and derivative functions and the second (b) relationship corresponds to the substitution for the fitted linear equation for the pressure-transient data. Once the fracture conductivity (and subsequently the fracture half-length) has been determined in the analysis, as an example, reservoir effective permeability to gas can subsequently be determined using Eq. 38 for assumed values of the dual porosity reservoir storativity ratio.

$$\begin{matrix}{X}_{f} = \frac{{n}_{f} {T}_{sc} h {k}_{f} w}{52674 {P}_{sc} T} [ \frac{Δ {P}_{p}}{{q}_{g}} - 2 t \frac{\partial ( \frac{Δ {P}_{p}}{{q}_{g}} )}{\partial t} ] - \frac{3 h}{π} [ ln ( \frac{h}{2 {r}_{w}} ) - \frac{π}{2} ] = {\frac{523954 {C}_{fD}}{ω {k}_{f} w φ \overline{{μ}_{g} {c}_{t}}} [ \frac{{P}_{sc} Tf ( {t}^{1 \text{/} 2} )}{{n}_{f} {T}_{sc} ht \frac{\partial ( \frac{Δ {P}_{p}}{{q}_{g}} )}{\partial t}} ]}^{2} & ( 41 a ) \\ {X}_{f} = \frac{{n}_{f} {T}_{sc} h {k}_{f} w}{52674 {P}_{sc} T} [ {a}_{1} - {a}_{2} f ( {t}^{1 \text{/} 2} ) ] - \frac{3 h}{π} [ ln ( \frac{h}{2 {r}_{w}} ) - \frac{π}{2} ] = {\frac{523954 {C}_{fD}}{ω {k}_{f} w φ \overline{{μ}_{g} {c}_{t}}} [ \frac{{P}_{sc} T}{{n}_{f} {T}_{sc} h {a}_{2}} ]}^{2} & ( 41 b ) \\ {X}_{f} = \frac{{n}_{f} {T}_{sc} h {k}_{f} w}{52674 {P}_{sc} T} [ \frac{Δ {P}_{p}}{{q}_{g}} - 2 t \frac{\partial ( \frac{Δ {P}_{p}}{{q}_{g}} )}{\partial t} ] - \frac{3 h}{π} [ ln ( \frac{h}{2 {r}_{w}} ) - \frac{π}{2} ] = {\frac{523954 {C}_{fD}}{( 1 + ω ) {k}_{f} w φ \overline{{μ}_{g} {c}_{t}}} [ \frac{{P}_{sc} Tf ( {t}^{1 \text{/} 2} )}{{n}_{f} {T}_{sc} ht \frac{\partial ( \frac{Δ {P}_{p}}{{q}_{g}} )}{\partial t}} ]}^{2} \\ {X}_{f} = \frac{{n}_{f} {T}_{sc} h {k}_{f} w}{52674 {P}_{sc} T} [ {a}_{1} - {a}_{2} f ( {t}^{1 \text{/} 2} ) ] - \frac{3 h}{π} [ ln ( \frac{h}{2 {r}_{w}} ) - \frac{π}{2} ] = {\frac{523954 {C}_{fD}}{( 1 + ω ) {k}_{f} w φ \overline{{μ}_{g} {c}_{t}}} [ \frac{{P}_{sc} T}{{n}_{f} {T}_{sc} h {a}_{2}} ]}^{2} & ( 42 a )\end{matrix}$$

Evaluation of Eqs. 11-17 results in an expression for directly determining the product of the reservoir effective permeability and the dual porosity reservoir parameters, ω and λ. This expression has been developed using the fourth linear flow regime pressure-transient solution and may be given by Eq. 43.

$$k ω λ = {\frac{6287450}{φ \overline{{μ}_{g} {c}_{t}}} [ \frac{{P}_{sc} Tf ( {t}^{1 \text{/} 2} )}{{d}_{f} {n}_{f} {T}_{sc} ht \frac{\partial ( \frac{Δ {P}_{q}}{{q}_{g}} )}{\partial t}} ]}^{2} = {\frac{6287450}{φ \overline{{μ}_{g} {c}_{t}}} [ \frac{{P}_{sc} T}{{d}_{f} {n}_{f} {T}_{sc} {ha}_{2}} ]}^{2} \qquad ( 43 )$$

With the result obtained with Eq. 43 for the product of the reservoir effective permeability and the dual porosity reservoir parameters, an evaluation procedure has been developed for determining the minimum and maximum values for the individual reservoir properties and well completion effectiveness. A range of assumed dimensionless fracture conductivity values are used to compute the corresponding fracture half-length that satisfies the relationships for the fracture conductivity given in Eq. 44. Values of the dual porosity reservoir parameters (ω and λ) may be provided to obtain a value of the reservoir effective permeability individually from the result obtained with Eq. 43.

$${k}_{f} w = {C}_{fD} {kX}_{f} = \frac{0.2618 {d}_{f} {C}_{fD} + 1.0472 {X}_{f} + h [ ln ( \frac{h}{2 {r}_{w}} ) - \frac{π}{2} ]}{\frac{{n}_{f} {T}_{sc} h}{50300 {P}_{sc} T} ( \frac{Δ {P}_{p}}{{q}_{g}} ) - \frac{0.0997 f ( {t}^{1 \text{/} 2} )}{{d}_{f} \sqrt{φ \overline{{μ}_{g} {c}_{t}} ( k ω λ )}}} \qquad ( 44 )$$

As an example, once the value of the effective fracture half-length has been determined that satisfies the relationships for the fracture conductivity given in Eq. 44, the corresponding fracture conductivity can then be determined using either of the relationships given in Eq. 44 by direct substitution.

### Example

### Linear Flow Diagnostic Analysis of Oil Reservoir Performance

Diagnostic analyses for linear flow behavior of a multiply-fractured horizontal well that is completed in an oil reservoir may also be constructed. A graph of the flow rate normalized pressure drawdown versus the linear flow superposition time function of production data that exhibits linear flow results in a linear pressure transient relationship whose derivative function has the same slope as the pressure function, except that it passes through the origin (has an intercept of 0) in the graphical analysis. For a single porosity oil reservoir, a linear flow analysis is developed from the relationships given in Eqs. 8, 14, and 17-19. The pressure-transient relationship given in Eq. 8 may also be applicable in dual porosity systems with either transient or pseudosteady state interporosity flow. The coordinates of a point on the pressure derivative curve during the linear flow period result in a value of the product of the reservoir effective permeability to oil and the square of the effective half-length. The substitution into the right half of Eq. 45 for the linear equation fitted relationship of the pressure-transient behavior defined by, for example:

$$[ \frac{Δ P}{qB} = {a}_{1} + {a}_{2} f ( {t}^{1 \text{/} 2} ) ] \\ {kX}_{f}^{2} = {\frac{4.1292 μ}{φ {c}_{t}} [ \frac{f ( {t}^{1 \text{/} 2} )}{{n}_{f} ht \frac{\partial ( \frac{Δ P}{qB} )}{\partial t}} ]}^{2} = {\frac{4.1292 μ}{φ {c}_{t}} [ \frac{1}{{n}_{f} {ha}_{2}} ]}^{2} \qquad ( 45 )$$

When the linear flow pressure-transient solutions given in Eqs. 9 and 10 are used in the analysis instead of the single porosity reservoir linear flow solution (Eq. 8), the resulting expressions for the product of the reservoir effective permeability to oil, square of the fracture half-length, and a function of the dual porosity reservoir storativity ratio that is obtained for the linear flow analysis of the production performance of an oil reservoir are given by Eqs. 46 and 47, respectively. These solutions correspond to the second and third linear flow analysis interpretive models for a multiply-fractured horizontal well that is completed in an oil reservoir.

$$\begin{matrix} ω {kX}_{f}^{2} = {\frac{4.1292 μ}{φ {c}_{t}} [ \frac{f ( {t}^{1 \text{/} 2} )}{{n}_{f} ht \frac{\partial ( \frac{Δ P}{qB} )}{\partial t}} ]}^{2} = {\frac{4.1292 μ}{φ {c}_{t}} [ \frac{1}{{n}_{f} {ha}_{2}} ]}^{2} & ( 46 ) \\ ( 1 + ω ) {kX}_{f}^{2} = {\frac{4.1292 μ}{φ {c}_{t}} [ \frac{f ( {t}^{1 \text{/} 2} )}{{n}_{f} ht \frac{\partial ( \frac{Δ P}{qB} )}{\partial t}} ]}^{2} = {\frac{4.1292 μ}{φ {c}_{t}} [ \frac{1}{{n}_{f} {ha}_{2}} ]}^{2} & ( 47 )\end{matrix}$$

Corresponding individual reservoir and well completion properties may then be evaluated as a solution of the balance of the effective fracture half-length relationships for the unknown fracture conductivity. For a single porosity reservoir, the expression that is used for determining the fracture half-length for linear flow of a multiply-fractured horizontal well in an oil reservoir is given by Eq. 48. This relationship may also be applicable for some dual porosity systems with transient and pseudosteady state interporosity flow. The (a) subscript designation this case corresponds to the form of the solution expressed in terms of the pressure and derivative functions and (b) corresponds to the solution expressed in terms of the fitted linear relationship for the production data.

$$\begin{matrix}{X}_{f} = \frac{{n}_{f} {hk}_{f} w}{147.9 μ} [ \frac{Δ P}{qB} - 2 t \frac{\partial ( \frac{Δ P}{qB} )}{\partial t} ] - \frac{3 h}{π} [ ln ( \frac{h}{2 {r}_{w}} ) - \frac{π}{2} ] = {\frac{147.9 {C}_{fD} μ}{{k}_{f} w φ {c}_{t}} [ \frac{f ( {t}^{1 \text{/} 2} )}{{n}_{f} ht \frac{\partial ( \frac{Δ P}{qB} )}{\partial t}} ]}^{2} & ( 48 a ) \\ {X}_{f} = \frac{{n}_{f} {hk}_{f} w}{147.9 μ} [ {a}_{1} - {a}_{2} f ( {t}^{1 \text{/} 2} ) ] - \frac{3 h}{π} [ ln ( \frac{h}{2 {r}_{w}} ) - \frac{π}{2} ] = {\frac{147.9 {C}_{fD} μ}{{k}_{f} w φ {c}_{t}} [ \frac{1}{{n}_{f} {ha}_{2}} ]}^{2} & ( 48 b )\end{matrix}$$

As an example, a solution procedure for evaluating the upper and lower limits of the individual reservoir and well completion parameters of interest may follow a procedure as previously described for a single porosity reservoir analysis, using an appropriate result of Eqs. 46 or 47 (e.g., instead of Eq. 45), and a value of the dual porosity reservoir storativity ratio. Expressions for evaluating effective fracture half-length using the second and third linear flow dual porosity reservoir models may be given by Eqs. 49 and 50.

$$\begin{matrix}{X}_{f} = \frac{{n}_{f} {hk}_{f} w}{147.9 μ} [ \frac{Δ P}{qB} - 2 t \frac{\partial ( \frac{Δ P}{qB} )}{\partial t} ] - \frac{3 h}{π} [ ln ( \frac{h}{2 {r}_{w}} ) - \frac{π}{2} ] = {\frac{147.9 {C}_{fD} μ}{ω {k}_{f} w φ {c}_{t}} [ \frac{f ( {t}^{1 \text{/} 2} )}{{n}_{f} ht \frac{\partial ( \frac{Δ P}{qB} )}{\partial t}} ]}^{2} & ( 49 a ) \\ {X}_{f} = \frac{{n}_{f} {hk}_{f} w}{147.9 μ} [ {a}_{1} - {a}_{2} f ( {t}^{1 \text{/} 2} ) ] - \frac{3 h}{π} [ ln ( \frac{h}{2 {r}_{w}} ) - \frac{π}{2} ] = {\frac{147.9 {C}_{fD} μ}{ω {k}_{f} w φ {c}_{t}} [ \frac{1}{{n}_{f} {ha}_{2}} ]}^{2} & ( 49 b ) \\ {X}_{f} = \frac{{n}_{f} {hk}_{f} w}{147.9 μ} [ \frac{Δ P}{qB} - 2 t \frac{\partial ( \frac{Δ P}{qB} )}{\partial t} ] - \frac{3 h}{π} [ ln ( \frac{h}{2 {r}_{w}} ) - \frac{π}{2} ] = {\frac{147.9 {C}_{fD} μ}{( 1 + ω ) {k}_{f} w φ {c}_{t}} [ \frac{f ( {t}^{1 \text{/} 2} )}{{n}_{f} ht \frac{\partial ( \frac{Δ P}{qB} )}{\partial t}} ]}^{2} & ( 50 a ) \\ {X}_{f} = \frac{{n}_{f} {hk}_{f} w}{147.9 μ} [ {a}_{1} - {a}_{2} f ( {t}^{1 \text{/} 2} ) ] - \frac{3 h}{π} [ ln ( \frac{h}{2 {r}_{w}} ) - \frac{π}{2} ] = {\frac{147.9 {C}_{fD} μ}{( 1 + ω ) {k}_{f} w φ {c}_{t}} [ \frac{1}{{n}_{f} {ha}_{2}} ]}^{2} & ( 50 b )\end{matrix}$$

Once fracture half-length relationships given in Eqs. 48, 49, or 50 are resolved for the value of fracture conductivity, the corresponding average effective fracture half-length may be determined using either form of the appropriate expressions given in these relationships. The reservoir effective permeability subsequently can be determined using Eq. 38.

A fourth interpretive model for linear flow of a multiply-fractured horizontal well in a low permeability fractured shale oil reservoir may be obtained by solution of Eqs. 11, 14, and 17-21. The solution of these relationships provides a direct means of evaluating the product of the reservoir effective permeability and dual porosity reservoir parameters.

$$k ω λ = {\frac{198.2 μ}{φ {c}_{t}} [ \frac{f ( {t}^{1 \text{/} 2} )}{{d}_{f} {n}_{f} ht \frac{\partial ( \frac{Δ P}{qB} )}{\partial t}} ]}^{2} = {\frac{198.2 μ}{φ {c}_{t}} [ \frac{1}{{d}_{f} {n}_{f} {ha}_{2}} ]}^{2} \qquad ( 51 )$$

With product of the reservoir effective permeability to oil and the dual porosity reservoir parameters obtained with Eq. 51, an evaluation procedure has been developed for determining the minimum and maximum values of the individual reservoir properties and well completion effectiveness. A range of assumed dimensionless fracture conductivity values are used to compute the corresponding fracture half-length that satisfies the relationships for the fracture conductivity given in Eq. 52. Values of the dual porosity reservoir parameters (ω and λ) may be provided to obtain a value of the reservoir effective permeability to oil individually from the result obtained with Eq. 51.

$${k}_{f} w = {C}_{fD} {kX}_{f} = \frac{0.2618 {d}_{f} {C}_{fD} + 1.0472 {X}_{f} + h [ ln ( \frac{h}{2 {r}_{w}} ) - \frac{π}{2} ]}{\frac{{n}_{f} h}{141.2 μ} ( \frac{Δ P}{qB} ) - \frac{0.0997 f ( {t}^{1 \text{/} 2} )}{{d}_{f} \sqrt{φ {c}_{t} ( k ω λ )}}} \qquad ( 52 )$$

With the value of the effective fracture half-length obtained with the relationships for the fracture conductivity given in Eq. 52, the corresponding fracture conductivity can then be determined using either of the relationships given in Eq. 52. The converging flow steady state skin effect (S_{c}) may then be evaluated using Eq. 17.

### Example

### History Matching

As an example, bilinear and linear flow regime production diagnostic analyses presented herein may be used to obtain initial estimates of individual reservoir properties and well completion effectiveness. As an example, for instances where specialized diagnostic analysis techniques do not result in a single value for the individual parameters, the upper and lower limits of the specific variable values may be established. Refinement of initial parameter estimates may then be obtained using a trilinear pressure-transient solution, for example, implemented using a nonlinear numerical inversion algorithm. As an example, various trials herein implemented a Levenberg-Marquardt method. As an example, a modification of the nonlinear regression analysis may be made to allow for imposition of optional constraints on one or more variable parameter values.

As an example, a computational analysis model can include (1) the production diagnostics previously discussed for the bilinear and linear flow behavior of multiply-fractured horizontal wells in oil or gas reservoirs, (2) a nonlinear regression analysis procedure coupled with a trilinear pressure-transient well performance model for history-matching well performance (e.g., as either a rate or pressure-transient analysis, with or without constrained regularization), (3) computational analyses for determining near well relative or effective permeability variations with respect to production time, and (4) material balance analyses for evaluating variation in reservoir pore pressure and average reservoir fluid saturations with respect to time.

As an example, a production analysis system can provide for evaluation of performance of low permeability oil and gas reservoirs, particularly with horizontal well completions that have been hydraulically fractured at multiple points along the wellbore, for better characterization of reservoir properties and well completion effectiveness using transient production data.

As an example, one or more well performance pressure-transient modeling and solution approaches may be implemented, for example, in a production performance computational analysis system (e.g., for forward simulation modeling). Such approaches, for a multiply-fractured horizontal well completion in low permeability shale reservoirs (e.g., possibly in excess of 100 completed intervals (perforation clusters)), size of matrices to solve those well performance problems may become somewhat impractical for use in a history matching procedure (e.g., noting that size of matrices to be solved may be directly a function of the completed intervals for which the production performance is to be resolved). As an example, a trilinear pressure-transient approach may help to alleviate such a burden and provide a more direct means of understanding and developing closed form approximations for one or more pertinent flow regimes that may be exhibited by multiply-fractured horizontal wells completed in low permeability shale reservoirs.

### Example

### Application to Field Cases

Application of one or more diagnostic and numerical inversion analyses may be demonstrated with an actual field example of production performance of a multiply-fractured horizontal well completed in a fractured shale gas reservoir. Field examples can also be quite useful in illustrating some of the many difficulties and limitations that may be encountered in practice when trying to apply one or more interpretation models and analysis techniques.

Some examples of prominent flow regimes that have been identified include (1) bilinear or initial linear, (2) early-radial, (3) compound-linear, (4) pseudoradial, and (5) boundary-dominated (pseudosteady state) flow regimes. A field example that was chosen for demonstration of various techniques described herein can illustrate issues associated with interpretation of transient performance of initial linear and compound-linear flow regimes of multiply-fractured horizontal wells completed in low-permeability gas and oil reservoirs using daily-recorded, surface-measured, composite well production data. As an example, high frequency, high resolution, downhole-recorded pressure measurements using a permanent gauge may be provided; noting that production data records often can be limited to surface daily-recorded values (e.g., which may preclude use of some derivative analyses).

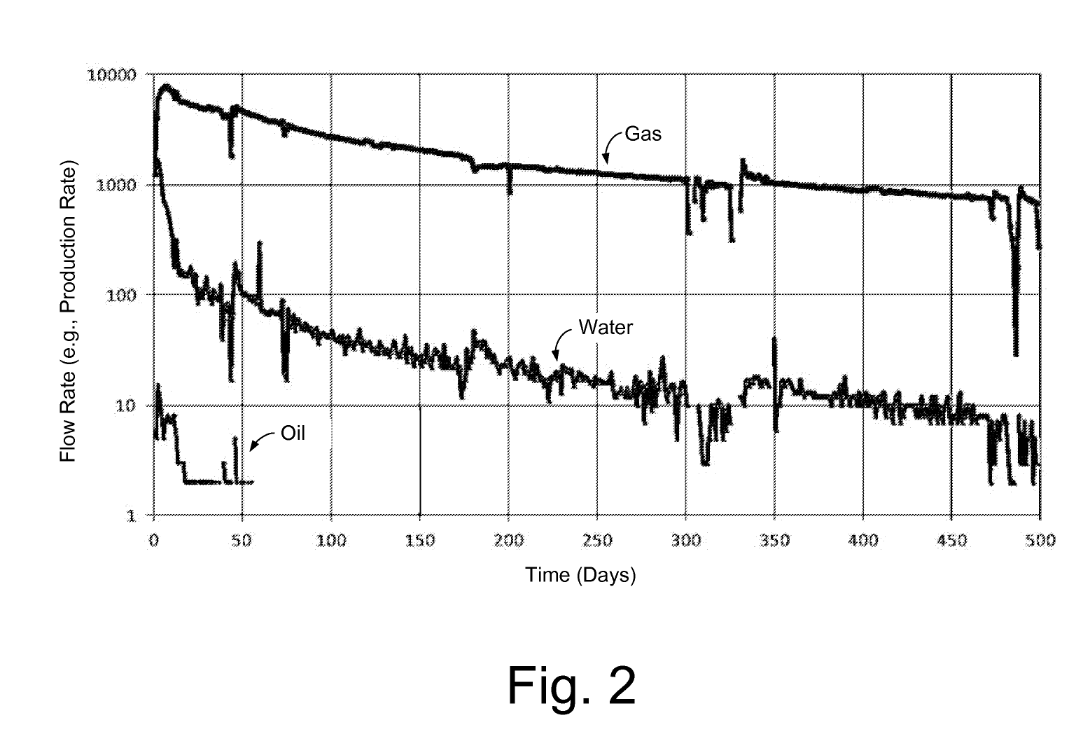

The production performance of a multiply-fractured horizontal well completed in a primarily gas-producing area of a formation was chosen as a field example. Production rate data of this well are presented in FIG. 2. A total of almost 500 days of production are depicted in the plot of FIG. 2. The well has produced mostly dry gas (almost 1 Bcf to date), with about 150 STB of condensate, and has recovered a little less than 24,000 STB of water (mostly frac water which dropped off steadily after about 50 days).

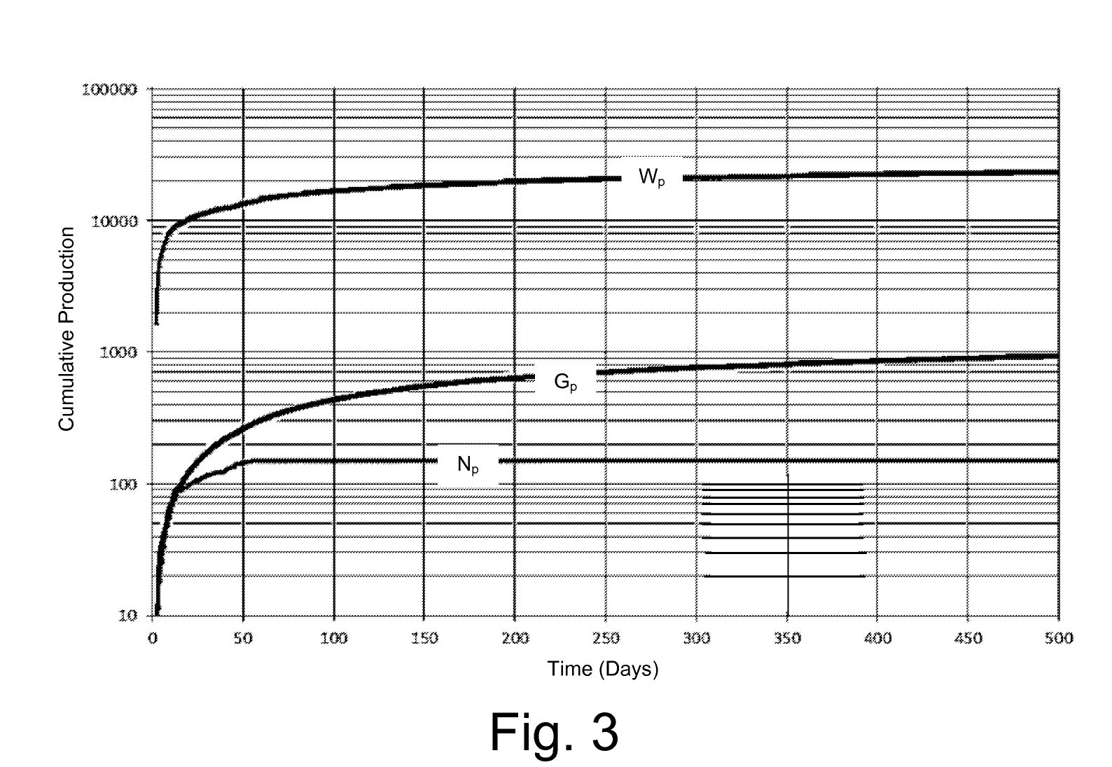

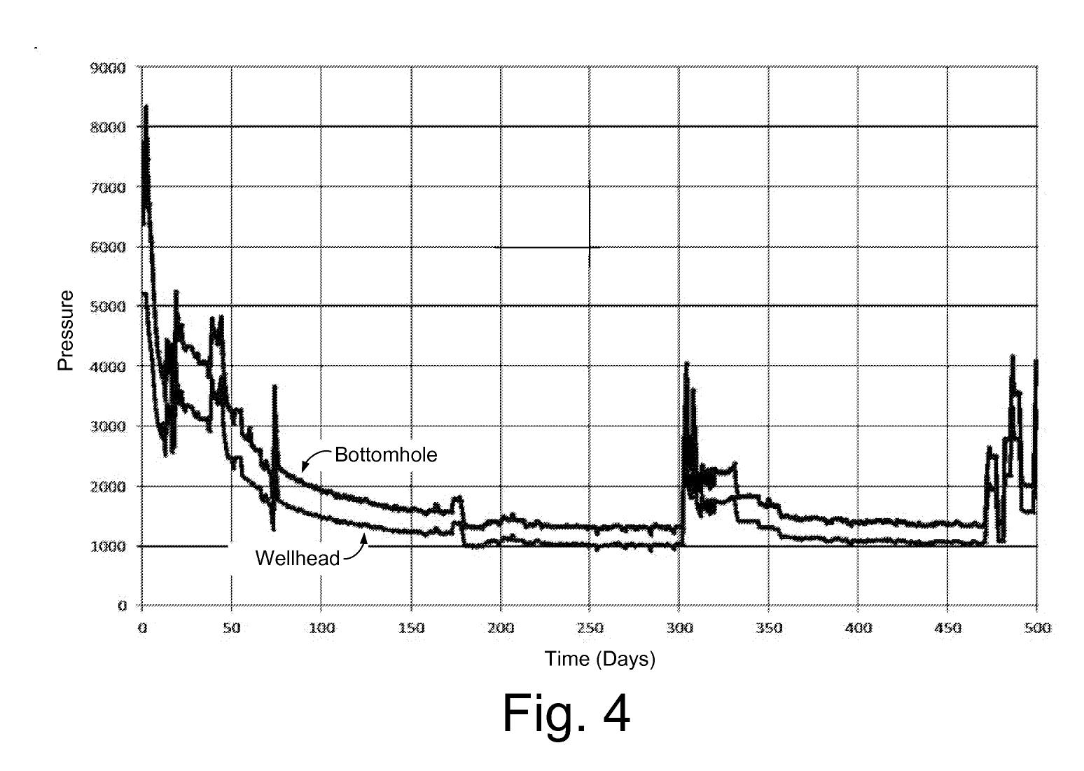

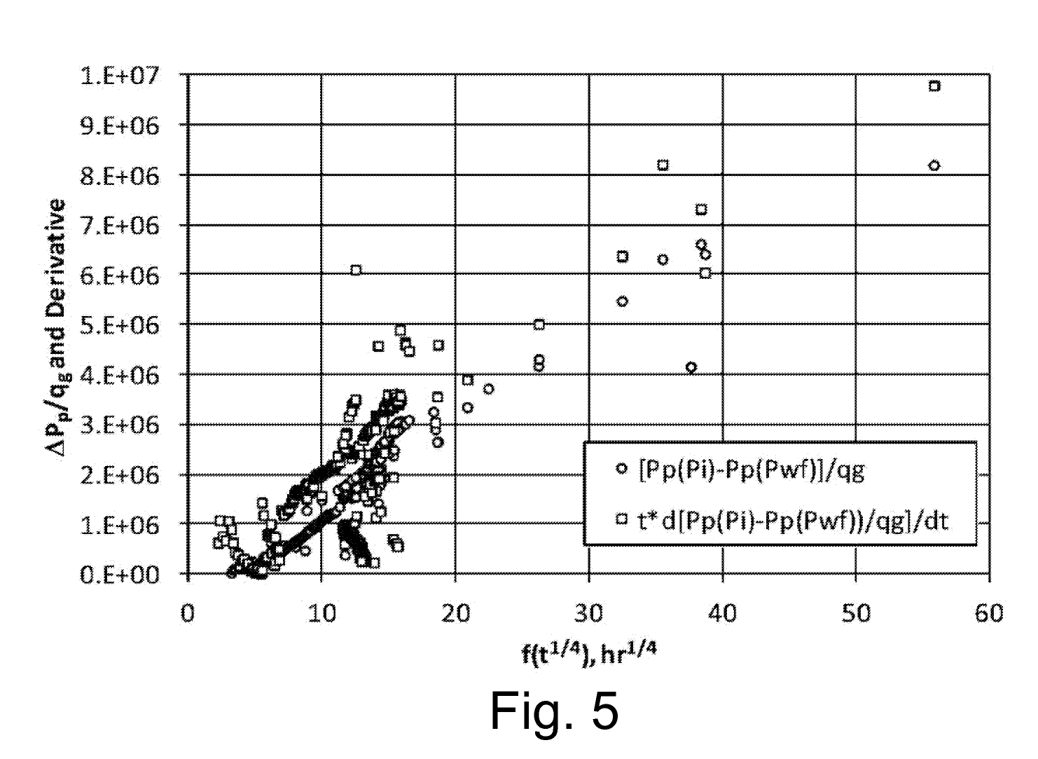

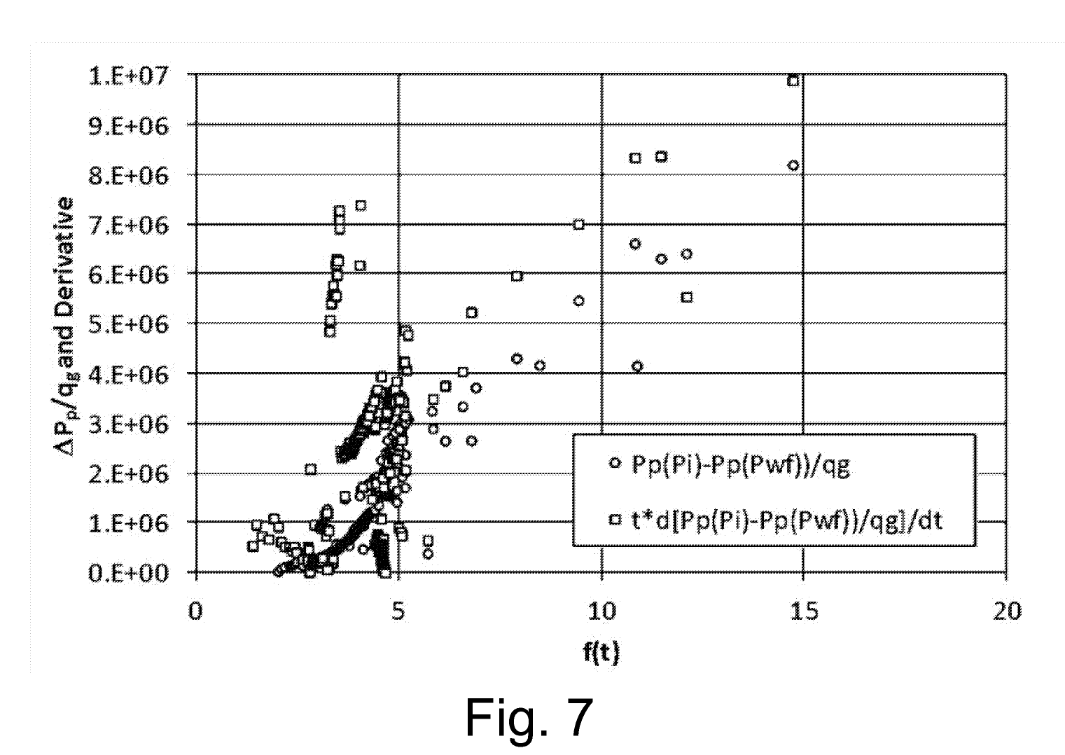

The cumulative production history of the example well is given in FIG. 3. The corresponding wellhead pressure and computed bottomhole pressure history for this production history are presented in FIG. 4. The first-look diagnostic graphs for the production history of this multiply-fractured horizontal gas well are presented in FIGS. 5 through 7 for the bilinear, linear and pseudoradial superposition time graphical analyses, respectively.

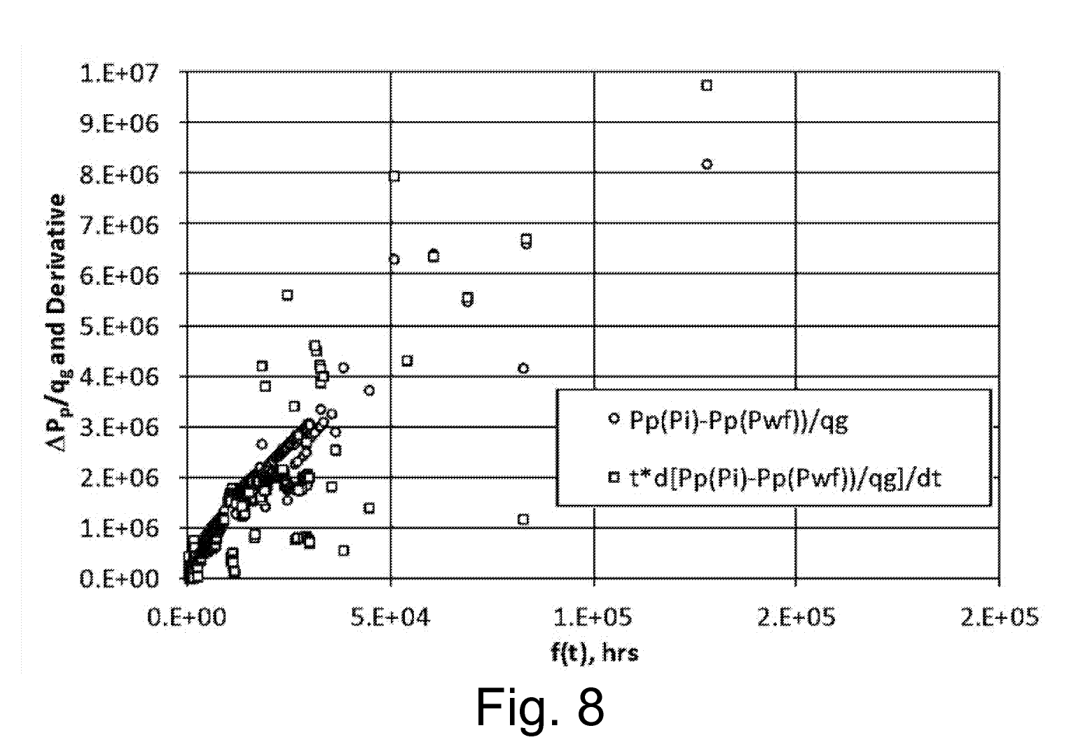

A superposition time diagnostic analysis of the pseudosteady state (boundary-dominated) flow regime may also be employed to determine if the appropriate pressure-transient and derivative signatures are also linear and parallel. The superposition time relationship for this flow regime has not been included in the previous discussion concerning the diagnostic relationships as was done for the bilinear, linear, and radial flow regimes (Eqs. 1, 2, and 3, respectively). However, the appropriate superposition time function can be constructed using the pseudosteady state pressure-transient solution, resulting in a superposition time function that is expressed in terms directly of time. This quick-look diagnostic analysis is presented in FIG. 8. Note that a linear trend appears to be exhibited in the pressure-transient behavior of the well in this figure beginning sometime after a superposition time function value of about 1×10⁴. This corresponds to an actual production time of approximately 6 months in this example. However, the derivative function signature for the same segment of the production performance tends to be scattered (e.g., as to determining whether pseudosteady state flow exists).

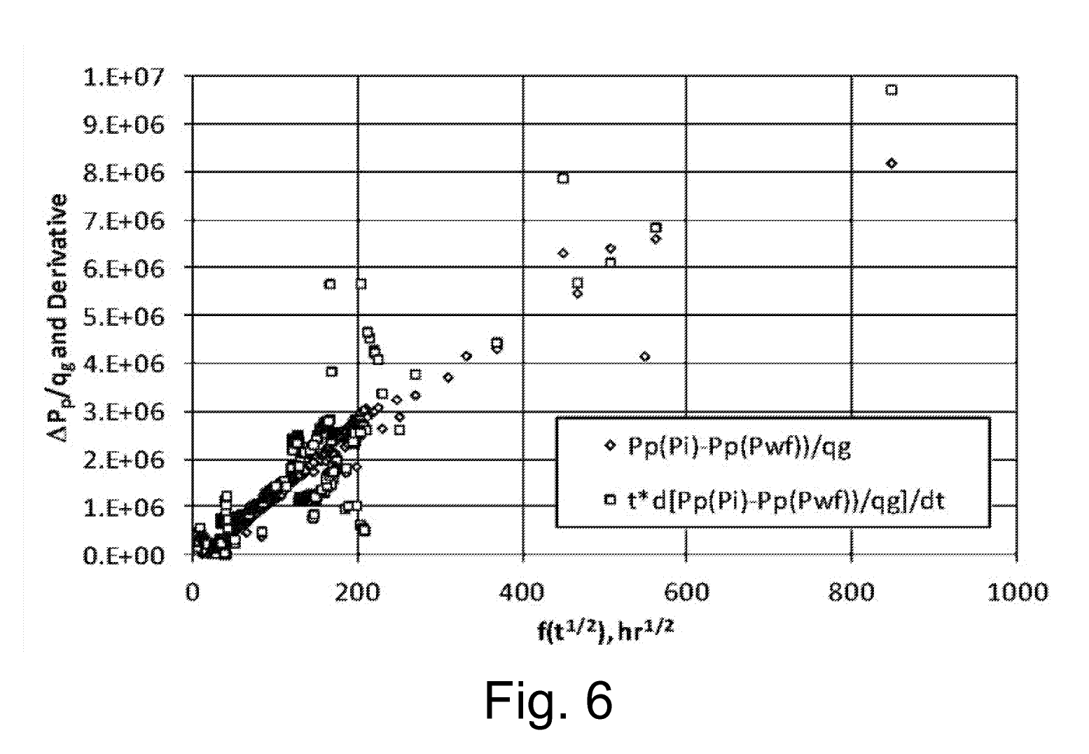

A review of the first-look diagnostic analyses presented in FIGS. 5 through 8 indicates that the production data tends to be linear flow (FIG. 6), which is what is commonly observed for a well of this completion type in a very low permeability fractured shale reservoir. In such an example, linear flow quantitative analyses may be indicated for characterizing production performance of such a well. If bilinear flow behavior is observed in a well's transient performance (e.g., indicative of a finite-conductivity fracture), relationships presented in Eqs. 30-38 may be used for quantitative production performance diagnostic analyses, and the corresponding relationships for the time to the end of the bilinear flow regime. Pseudoradial and boundary-dominated (pseudosteady state) flow analyses may not necessarily be warranted for the particular example well.

As an example, where bottomhole pressure history of the well has been recorded using a high resolution (and high sampling frequency) downhole gauge, derivative function values computed from production data may be useful for quantitative interpretation. A pressure-transient signature may tend to be smooth enough that a reasonably good linear correlation can be obtained using the flow rate normalized pressure drawdown function instead of a derivative function. Another alternative may be to switch to use of rate-transient based analyses involving use of drawdown-normalized flow rates and cumulative production system responses, for example, without a need for computation of derivative values of noisy recorded values of the transient behavior of the well.

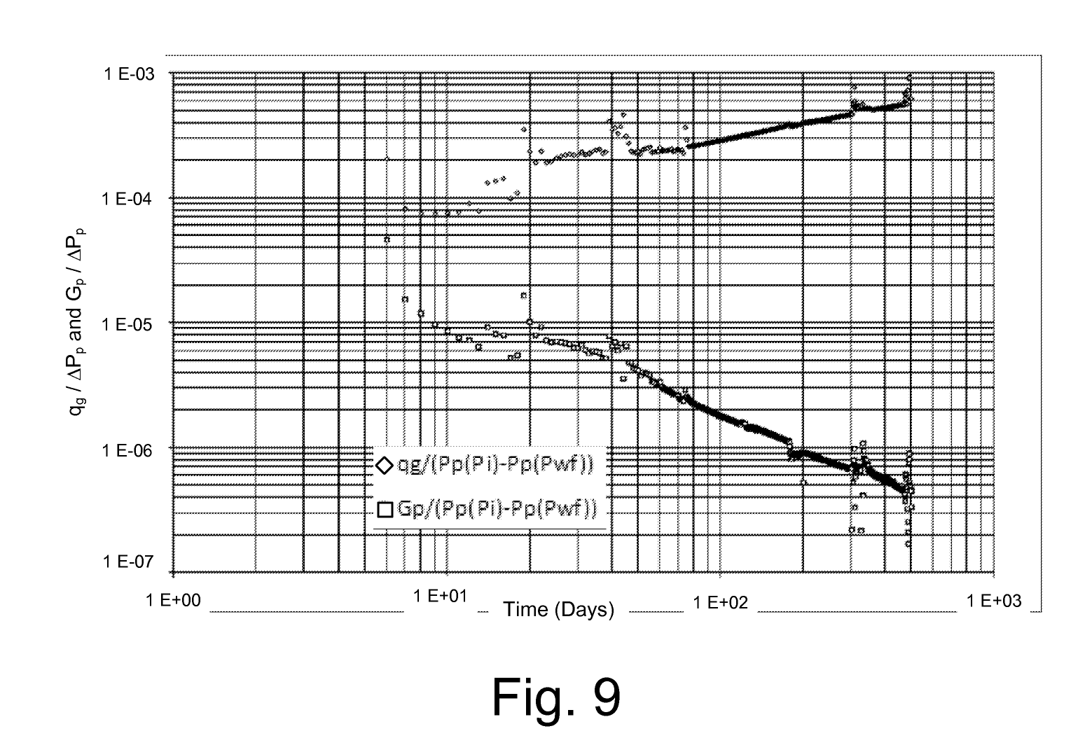

As a further verification of the presence of linear flow in a well's production performance, a log-log diagnostic plot of the pseudopressure drawdown normalized flow rate and cumulative production (e.g., applicable for rate-transient based analyses) may be analyzed for indication of a log-linear flow behavior. This depiction of the well's production performance is presented in FIG. 9. Note that both the flow rate and cumulative production functions exhibit log-linear behaviors for portions of the production history; noting an exception to this behavior for very early transient behavior that appears to indicate a period of post-stimulation treatment cleanup effects distortion of the well's transient production performance behavior. The effect of the presence of external reservoir limits also does not appear to be exhibited in the well's production behavior. The production performance of the well can therefore be evaluated with the assumption of an infinite-acting reservoir system.

Since production performance of a well has been identified as being linear flow, a linear relationship can be more readily and reliably fit through the linear flow pressure-transient data of FIG. 6 instead of the derivative function values; noting that actually multiple mechanisms in multiply-fractured horizontal well completions in low-permeability reservoirs can result in a linear flow production performance. For example, consider contrast in relative conductivities of a fracture and a reservoir. As an example, a dimensionless fracture conductivity (Eq. 14) of about 80 or more can result in a linear flow behavior in a well's early transient performance. An elongated source/sink in a system (e.g., selectively completed horizontal wellbore) also may produce a linear flow behavior that can last a relatively long time (e.g., previously referred to as compound-linear flow). In various cases with this type of well completion, it has been found in practice that linear flow behavior exhibited in a well's production performance is due to a combination of mechanisms.

Quantitative diagnostic and history match analyses may be performed initially using diagnostic analyses as described herein. Results of production analyses for fracture-dominated linear flow may be evaluated to determine contribution to linear flow behavior that may be attributable to contrast in reservoir and fracture properties (e.g., initial linear flow) and later those due to the selectively-completed stimulated horizontal well in the system (e.g., compound-linear flow). Initial infinite-acting reservoir fracture-dominated linear flow behavior may be expected to end at a dimensionless time of about 0.016, or sooner if the fracture spacing (d_{f}) is sufficiently small such that interference between adjacent fractures becomes the dominant mechanism governing the end of the fracture-dominated initial linear flow regime. The development of an example of a suitable relationship for the production time to the end of the fracture-dominated initial linear flow regime is presented in the Appendix.

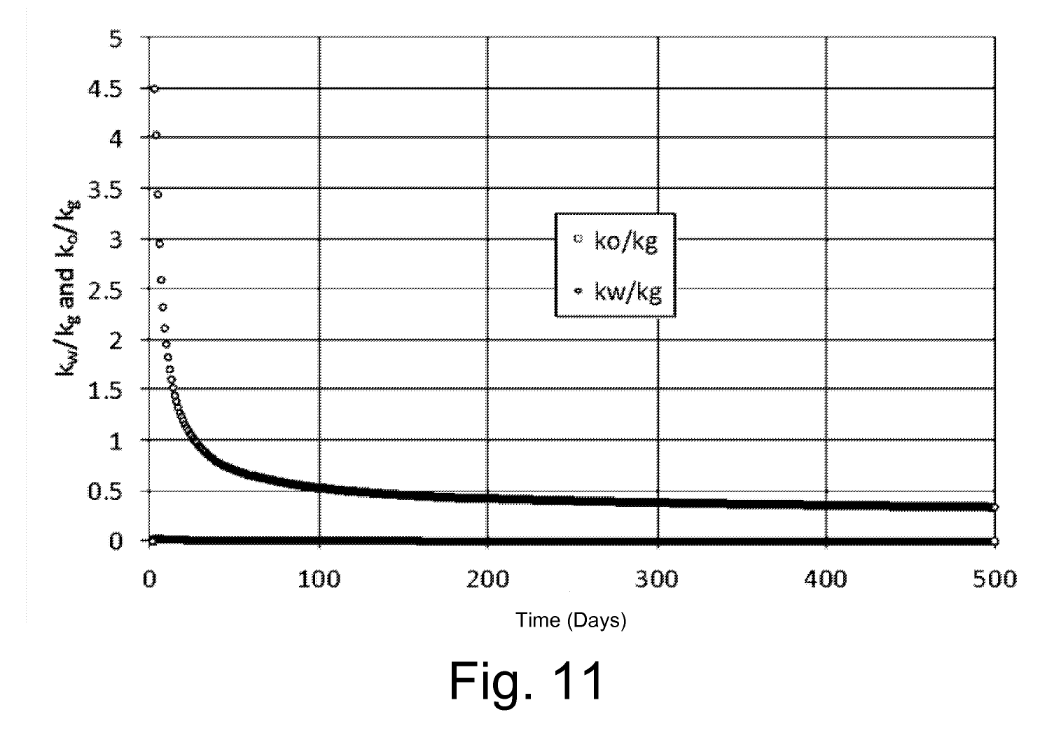

Post-treatment production of the example well exhibited a moderate amount of post-treatment flowback of the fracturing fluid. Therefore, proper selection of the linear flow pressure-transient behavior for quantitative analyses can involve selection of the very early-time production data, since it may be most heavily distorted by fracturing fluid production. As an example, this may be accomplished by human or machine observation of production performance, for example, as depicted in FIG. 9 (e.g., also observed later in FIG. 11). Fracture-dominated linear flow behavior can occur quite early in a well's production performance, almost from the beginning. As an example, this may be later followed by a linear flow behavior that is governed by horizontal wellbore length that is completed in a low-permeability reservoir (e.g., compound-linear flow).

As shown in FIGS. 9 and 11, water production rate appears to stabilize after about 100 days of production. The fit of the compound-linear flow behavior data may therefore start after at least 100 days of post-treatment production in this example well to stand in for the longer-term production behavior of the well. An early pseudoradial flow regime between the end of the initial fracture linear and later compound-linear flow behaviors does not appear to be exhibited in the well's production performance due to the effects of interference between fractures in the system.

As an example, reservoir and well completion information that may be provided for a quantitative analysis of the well's production performance are given in Table 1. A linear flow diagnostic analysis that uses the single porosity reservoir relationship (Eq. 34) indicates that the product of the reservoir effective permeability and square of the fracture half-length is equal to 0.057 md-ft². It has been found in practice that the single porosity relationships of both the bilinear and linear flow regime diagnostic analyses are good for obtaining initial parameter estimates in the inversion analysis. Similarly, the kX_{f}² product determined using the second (Eq. 39) and third (Eq. 40) dual porosity reservoir models assuming a dual porosity reservoir storativity ratio of 0.1 indicate kX_{f2} product values of 0.568 and 0.052 md-ft², respectively. The fourth dual porosity reservoir model (Eq. 43) provides an estimate of the reservoir effective permeability and dual porosity reservoir parameters (kωλ) of 0.00034 md.

TABLE 1
Reservoir and well completion properties of example well.

| | | | | |
|---|---|---|---|---|
| h = 174 ft | d_{f} = 45.5 ft | n_{f} = 108 | φ = 5% | S_{w} = 30% |
| r_{w} = 0.28 ft | Pᵢ = 6040 psia | T = 307° F. | φ = 30% | S_{wf} = 100% |

| | | |
|---|---|---|
| μ_{gi} = 0.0241 cp | cₜᵢ = 1.0088 × 10⁻⁴ 1/psia | B_{g} = 1.0787 rb/Mscf |

The corresponding minimum and maximum parameter estimates obtained with the single porosity reservoir diagnostic analyses (Eqs. 34 to 38) are then used as the initial parameter estimates in the nonlinear regression history-matching procedure. The reservoir effective permeability was found to be bounded between 8.6×10⁻⁷ and 1.58 md. A minimum fracture conductivity of 0.14 md-ft and a half-length of 110 ft were determined as the initial parameter estimates for the inversion history match procedure for the example well production performance. The corresponding minimum and maximum values for the converging flow steady state skin effect (S_{c}) indicated in the diagnostic analysis were found to be 0.00306 and 0.0821. Therefore, the bounding values for the converging flow steady state skin effect determined in the diagnostic analysis demonstrate that it would have a minor effect on the near well flow efficiency of the multiply-fractured horizontal well completion in this example.

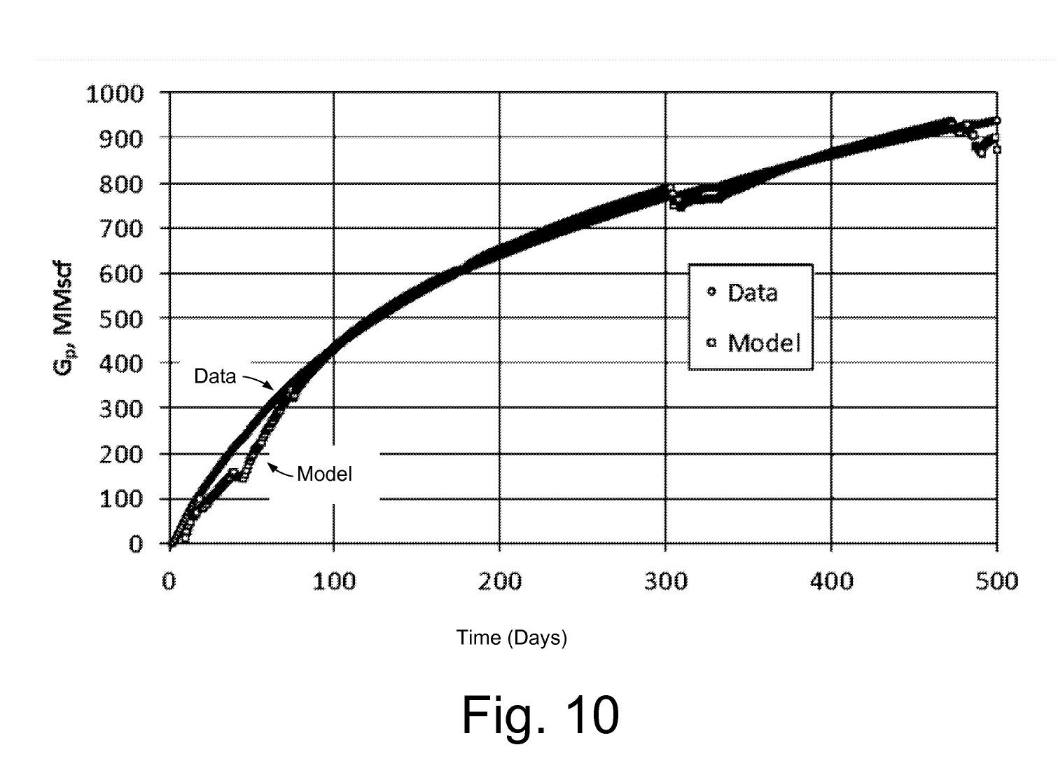

A nonlinear regression inversion analysis of the example well performance data was then performed using the numerical inversion model. As an example, an inversion model can have an option of performing a pressure- or rate-transient analysis of production data, with options for using a variety of variables as the dependent variable response function. In this case, the match parameter selected was the cumulative gas production (Gₚ) and the corresponding rate-transient inversion analysis match performed using the example well data is presented in FIG. 10. Other inversion history match response variables may be used in an analysis. The wellbore flow rate may also be used as response function in rate-transient analyses, or in pressure-transient mode bottomhole flowing pressure or derivative function could also be used as the response variable in an inversion analysis.

The nonlinear inversion procedure reduced the χ² residual of the match down to about 4.52 in 5 iterations. The final match results obtained with the inversion analysis with the trilinear solution indicates that the final apparent average effective fracture half-length was about 41.8 ft, a reservoir effective permeability to gas of about 0.00022 md, and the dimensionless fracture conductivity was greater than about 300 (e.g., practically infinite conductivity behavior). The surface area of the stimulated reservoir volume (SRV) of the reservoir was found to encompass about 10.4 acres. Even though the system had previously been determined to be infinite-acting, a reservoir drainage area of at least about 106 acres was indicated from the system match. The inversion was also made with the dual porosity parameters as variables and the best match of the well's production performance indicated that the reservoir was a single porosity system (ω=1). If a dual porosity reservoir had been indicated in the well's performance, a dual porosity reservoir analysis may have been performed.

The reservoir effective permeability obtained in the inversion history-matching analysis (e.g., based on 499 days of data) lies within the range of the diagnostic analysis limits, but the fracture half-length obtained from the history match is quite a bit less than the minimum fracture half-length determined for the linear flow diagnostic analyses. The differences between the reservoir effective permeability and fracture half-length estimates obtained from the early-transient production diagnostics reported earlier in this paper and those obtained with the regression analysis using a trilinear pressure-transient solution lie in the fact that initially (during fracture-dominated linear flow) the directional reservoir effective permeability in the Y direction (k_{y}, flow normal to the fracture plane, see FIG. 1) governs the pressure-transient behavior, while later during the compound-linear flow regime, the bulk reservoir effective permeability in the X direction (kₓ, flow normal to the horizontal wellbore and parallel to the fracture plane) governs the pressure-transient behavior of the well. If the production performance data is of even greater duration such as to also exhibit the later pseudoradial or boundary-dominated flow regimes, the effective permeability that is observed in those flow regime analyses would correspond to the geometric mean effective permeability of the system given by:

k=\sqrt{kₓk_{y}}.

This transition in the directional reservoir effective permeability, governed initially by the bulk Y direction effective permeability (permeability of matrix and natural fissures, if present) k_{y} in the initial linear flow regime, to kₓ (permeability of matrix, natural fissures, and a very strong component to the directional permeability contributed by the vertical hydraulic fractures) during the compound-linear flow regimes, also affect the resolution of the fracture half-length and fracture conductivity estimates obtained in the analyses. A trilinear pressure transient solution used in the inverse analysis has the capability to consider a contrast in the idealized 1D flow effective permeabilities of the SRV region and the reservoir region outside the SRV that is beyond the tips of the fractures (MO. However, such a model may not have the capability of directly considering the directional effective permeabilities (kₓ and k_{y}) separately within the SRV. Yet, this may be offset by the effect of the contribution of the vertical hydraulic fractures to the bulk effective permeability observed during the compound-linear flow regime, in which the effective half-length of the fractures separately have a secondary effect and are more difficult to discern from the pressure-transient behavior of the well.

With a high enough dimensionless fracture conductivity (C_{fD}>300), pressure drop due to flow in a fracture may be negligible and pressure-transient behavior of the fracture may be about that for fracture conductivities of 300 or higher. Fracture conductivity estimates obtained by the inverse analysis may be unaffected by a transition in a governing directional effective permeability of transient behavior, for example, as long as they are high enough that a dimensionless fracture conductivity of 300 or more exists, which may be found in some multiply-fractured horizontal wells that are completed in low-permeability fractured shale reservoirs. However, the fracture half-length estimates obtained from the inverse analysis may be affected by the increase in the apparent reservoir effective permeability caused by the rotation of principal flow directions and associated effective permeability values obtained for the initial fracture linear and compound-linear flow regimes.

An evaluation experiment that demonstrated the effect on the results obtained from production performance analyses due to a progression from initial fracture linear flow to compound-linear flow of a multiply-fractured horizontal well is summarized in Table 2. The inverse analysis of the production performance of this well was evaluated at various cumulative production time levels, beginning at about 25 days (characteristic of the early transient fracture-dominated linear flow behavior) and progressing up to the total production time of about 499 days. Note that the apparent fracture half-length varies from about 131 ft for the initial 25 days production, down to approximately 40 ft within the first 150 days of production, and remains relatively stable thereafter while the estimated reservoir effective permeability increases from about 4.6×10⁻⁵ md to about 2×10⁻⁴ md (e.g., order of magnitude increase), during the same time on production. These results indicate that an effective fracture half-length that is actually representative of the system (e.g., with a directional effective permeability normal to the fracture, k_{y}), can be obtained with just a very few days on production (less than 1 month) under fracture initial linear flow conditions.

The X direction bulk effective permeability and corresponding apparent fracture half-length (indicative of compound-linear flow) that is obtained from the inverse analysis with at least about 100 to about 150 days of production is a result of the effect of transition in the linear flow of the system from normal to the fracture planes to a direction more orthogonal to the principal axis of the horizontal wellbore. The corresponding bulk effective permeability of the system can also be relatively consistently estimated for this well after about 100 to about 150 days of production as well. The investigation of the effect of the progression of flow regimes on the apparent reservoir effective permeability and effective fracture half-length has also been repeated using synthetic production data, with similar results being observed for the parameter estimates that were obtained.

TABLE 2
Inverse analysis results for various cumulative production times.

| tₚ, days | k, md | X_{f}, ft | SRV, ac | χ² | Iterations |
|---|---|---|---|---|---|
| 25 | 4.57 × 10⁻⁵ | 131.5 | 32.6 | 10.9 | 2 |
| 50 | 1.19 × 10⁻⁴ | 81.1 | 20.1 | 4.39 | 3 |
| 100 | 2.99 × 10⁻⁴ | 39.1 | 9.7 | 5.64 | 8 |
| 150 | 2.44 × 10⁻⁴ | 39.9 | 9.9 | 6.09 | 10 |
| 200 | 2.12 × 10⁻⁴ | 41.7 | 10.4 | 5.54 | 8 |
| 300 | 1.72 × 10⁻⁴ | 45.5 | 11.3 | 4.94 | 8 |
| 400 | 1.93 × 10⁻⁴ | 43.1 | 10.7 | 4.55 | 6 |
| 499 | 2.02 × 10⁻⁴ | 41.8 | 10.4 | 4.52 | 5 |

Note that the approximate time to the end of fracture-dominated linear flow in a completely infinite-acting system (Eq. 36) determined for the reservoir parameter values given in Table 1 and the fracture half-length and effective permeability from the history match after about 25 days result in a time to the end of the fracture initial linear flow regime of about 2791 hrs (116.3 days). However, the time to the onset of interference effects between adjacent fractures is determined using the example development presented in the Appendix to be about 415.5 hrs (17.3 days). Therefore, the time to the onset of interference effects determines the end of the initial fracture linear flow behavior in this case (X_{D}=d_{f}/2X_{f}=0.173). The length of the selectively-completed stimulated horizontal wellbore that is completed in the pay zone in this case is about 4914 feet (D=n_{f}d_{f}). The majority of the linear flow behavior exhibited in the production performance of this well (see, e.g., FIGS. 6 and 9) is therefore more a result of the length of the selectively-completed horizontal wellbore in the reservoir and the distance between the outermost hydraulic fractures in the system (e.g., compound-linear flow) than is due to the early-time initial linear flow that is attributable to the fractures. With the low effective permeability to gas, the linear flow behavior of this elongated system can last for quite a long time in an infinite-acting reservoir system.

In multiply-fractured horizontal wells (e.g., with a large number of vertical fractures, closely-spaced) that are completed in infinite-acting reservoirs, compound-linear flow durations may be greater than those previously reported (see, e.g., Raghavan et al.). As an example, an analysis may provide a relationship for the production time to observe the start, end, and duration of the compound-linear flow regime of multiply-fractured horizontal wells.

When compound-linear flow behavior is exhibited in a multiply-fractured horizontal well's performance, as an example, the X direction effective permeability may be evaluated from the slope (m) of a Cartesian graphical analysis of the pressure-transient behavior of the well as a function of the linear flow (square of time) superposition time. This relationship may be given by Eq. 53 for liquid flow analyses. A relationship for computing the X direction effective permeability in a gas reservoir analysis of compound-linear flow can also be derived. As an example, slope of pressure-transient behavior during compound-linear flow may be a function of the number of fractures (n_{f}) intersecting the wellbore, for example, with an upper limit of \sqrt{π} as the number of fractures approaches oo. As an example, approximate estimates of the number of contributing fractures intersecting the wellbore may be derived from the compound-linear behavior of the well.

$${k}_{x} = \frac{μ}{φ {c}_{t}} ( \frac{8.128 qB}{mDh} ) \qquad ( 53 )$$

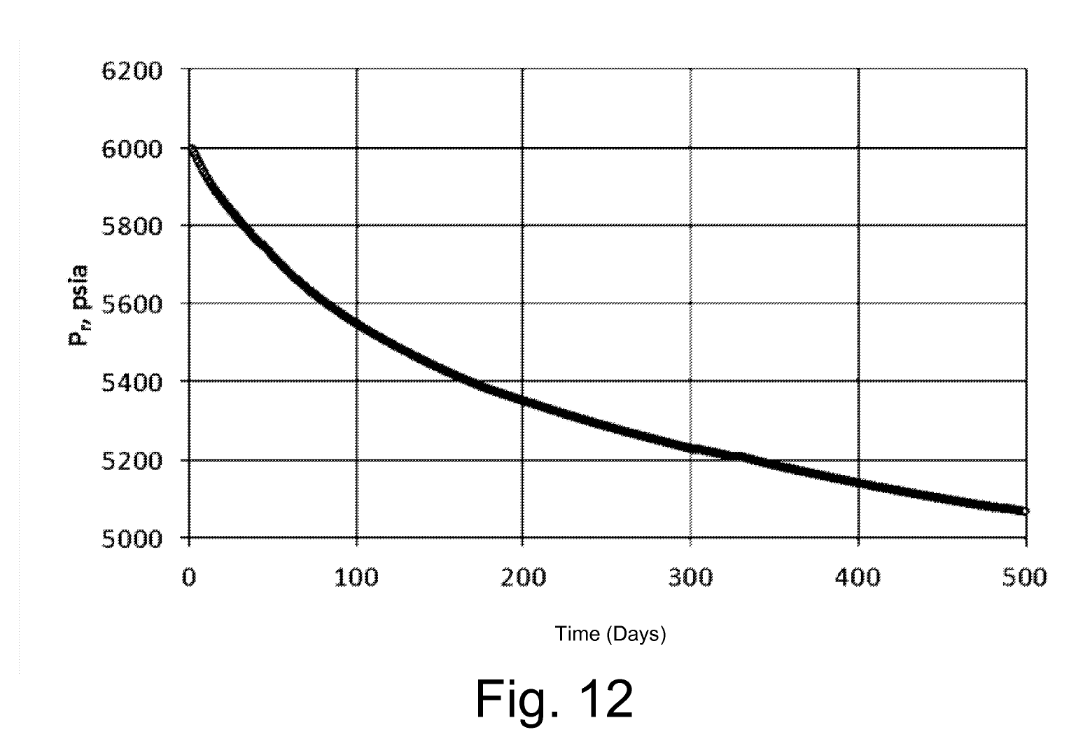

As an example, another production diagnostic analysis that may be evaluated for a well's production performance is the computation of the producing effective permeability ratios for each of the reservoir fluids. The effective permeability ratios that have been computed for the example well performance data is given in FIG. 11. The effective permeability ratios are computed using the production rate data, along with the idealization assumptions of (1) negligible gravitational and capillary effects, (2) equal flow potential for fluid phases, and (3) average and constant viscosities and formation volume factors of the produced fluids. The corresponding material balance analysis average reservoir pressure history that has been computed for this example well, using the minimum reservoir drainage area that was determined in the inversion analysis, is presented in FIG. 12.

As an example, once production performance match has been adequately obtained, specified well and reservoir model and inverted parameter values can then be used to forecast the future production performance of the well if the effects of some or all of the parameters have been exhibited in the well's production performance. In this case however, the effect of the reservoir drainage area actual physical size was not clearly exhibited in the well's production performance (e.g., it was still an infinite-acting reservoir system (no lateral boundaries observed in the well's transient performance) even though it had interference between adjacent fractures). A forecast of long-term production behavior of a well may consider drainage area size, for example, as determined by geological or seismic information.

As an example, for estimating drainage area of a reservoir using a well's transient production performance data may employ a specialized production decline analysis technique. As an example, production decline curves may be constructed using a general rate-transient solution for a multiply-fractured horizontal well that is completed in a low permeability fractured shale reservoir. Such an approach may include development of a sufficiently large number of characteristic production decline curve sets that would encompass system parameters; noting that a large number of reservoir properties and well completion effectiveness parameters present inherent in an inverse problem for the production performance of multiply-fractured horizontal wells may make it resource intensive to construct production decline curves.

### Overview of Examples

Linear flow behavior may be exhibited in transient production performance of multiply-fractured horizontal wells completed in low-permeability reservoirs, for example, due to a combination of reservoir and well completion mechanisms. Such mechanisms may include the early-transient fractured-dominated linear flow due to a contrast in the relative conductivities of the fracture and the reservoir (C_{fD}>80), and the long effective completed (and stimulated) length of the horizontal wellbore in the reservoir.

Interference effects may be observed in the production performance of multiply-fractured horizontal wells completed in low-permeability oil and gas reservoirs. A correlation has been developed for estimating the time to the end of the initial fracture linear flow regime that considers the effects of interference before adjacent fractures, the lesser of the time to the end of fracture linear flow in an infinite-acting system

$$and {t}_{Delf} \approx \frac{{X}_{D}^{2}}{4 π} . \qquad ( Eq . 36 ) ,$$

Interference effects can result in a reduction in the apparent fracture length. Effective reservoir permeability obtained from an inverse analysis of the production performance tends to increase as the well performance transitions from fracture-dominated linear flow to more of a stimulated horizontal wellbore linear flow performance.

Diagnostic graphical analyses of prominent flow regimes that may be exhibited by a multiply-fractured horizontal well completed in a low-permeability fractured shale reservoir may be developed and used to help characterize the reservoir properties and the well completion effectiveness.

Superposition time graphical diagnostic analyses of the bilinear, linear, pseudoradial, and boundary-dominated flow behavior of the production data of multiply-fractured horizontal oil or gas wells may be used to quickly identify which type of flow behavior is being exhibited in the well's performance. The identification of the appropriate flow regime exhibited in the well performance is readily made by determining which of the graphical diagnostic analyses result in a superposition time linear behavior of the pressure-transient function (ΔPp/q_{g} or ΔP/qB).

A trilinear solution for the pressure-transient behavior of multiply-fractured horizontal wells in low permeability fractured shale reservoirs provides a means of production performance analysis using nonlinear regression inversion procedures. Its application, however, may in some circumstances be limited to early production histories in which a well's production performance is governed primarily by drainage of the stimulated reservoir volume (SRV).

The well production performance evaluation procedures described herein may be applicable for single and dual porosity reservoirs, for example, including transient and pseudosteady state interporosity flow dual porosity systems.

A linear fit of the pressure-transient behavior rather than the derivative function response has been found to be of more practical use in constructing graphical production performance diagnostic analyses using typical daily-recorded surface-measured production data for multiply-fractured horizontal wells in low permeability gas and oil reservoirs, due to the level of noise exhibited in the computed derivatives for typical production data records. High-frequency and high-resolution downhole pressure measurements may alleviate this difficulty, permitting the use of derivatives in the production analyses.

### Example

### System

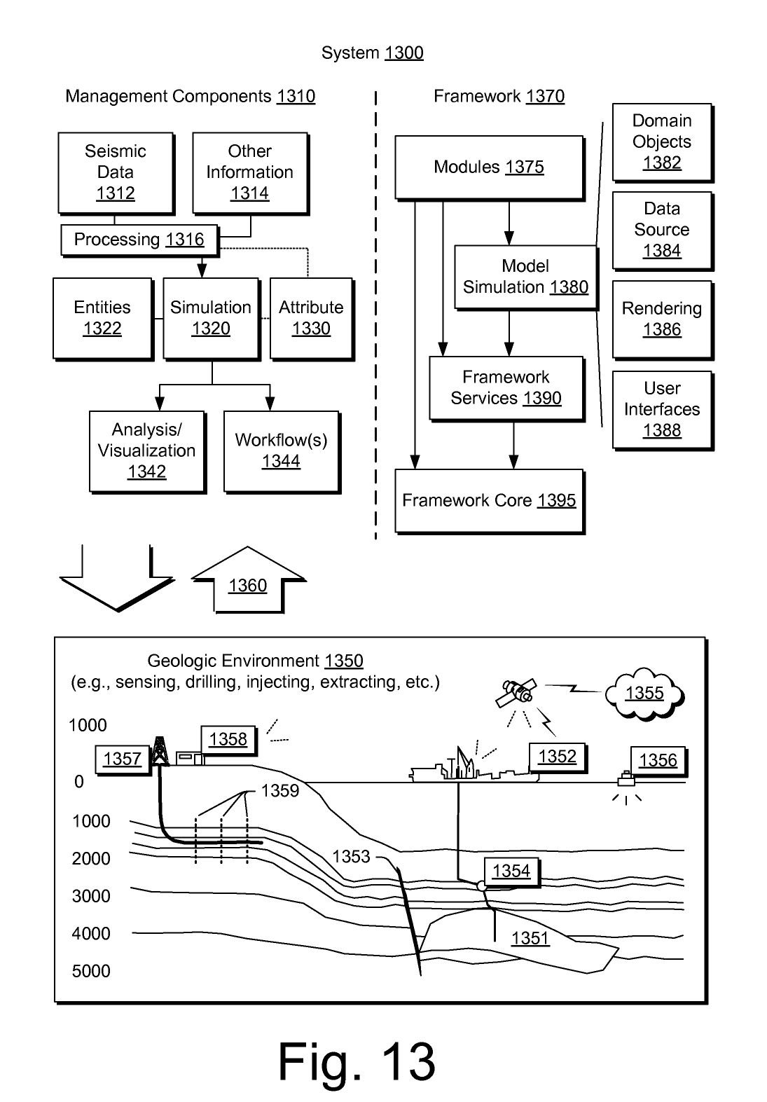

FIG. 13 shows an example of a system 1300 that includes various management components 1310 to manage various aspects of a geologic environment 1350 (e.g., an environment that includes a sedimentary basin, a reservoir 1351, one or more fractures 1353, etc.). For example, the management components 1310 may allow for direct or indirect management of sensing, drilling, injecting, extracting, fracturing, etc., with respect to the geologic environment 1350. In turn, further information about the geologic environment 1350 may become available as feedback 1360 (e.g., optionally as input to one or more of the management components 1310).

In the example of FIG. 13, the management components 1310 include a seismic data component 1312, an additional information component 1314 (e.g., well/logging data), a processing component 1316, a simulation component 1320, an attribute component 1330, an analysis/visualization component 1342 and a workflow component 1344. In operation, as an example, seismic data and other information provided per the components 1312 and 1314 may be input to the simulation component 1320 (e.g., optionally via the processing component 1316 or another component, etc.).

In an example embodiment, the simulation component 1320 may rely on entities 1322. Entities 1322 may include earth entities or geological objects such as wells, surfaces, reservoirs, etc. In the system 1300, the entities 1322 can include virtual representations of actual physical entities that are reconstructed for purposes of modeling, simulation, etc. The entities 1322 may include, for example, entities based on data acquired via sensing, observation, etc. (e.g., the seismic data 1312 and other information 1314). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 1320 may operate in conjunction with a software framework such as an object-based framework. In such a framework, entities may include entities based on pre-defined classes to facilitate modeling and simulation. A commercially available example of an object-based framework is the MICROSOFT®.NET™ framework (available from Microsoft Corporation, Redmond, Wash.), which provides a set of extensible object classes. In the .NET™ framework, an object class encapsulates a module of reusable code and associated data structures. Object classes can be used to instantiate object instances for use in by a program, script, etc. For example, borehole classes may define objects for representing boreholes based on well data.

In the example of FIG. 13, the simulation component 1320 may process information to conform to one or more attributes specified by the attribute component 1330, which may include a library of attributes. Such processing may occur prior to input to the simulation component 1320 (e.g., consider the processing component 1316). As an example, the simulation component 1320 may perform operations on input information based on one or more attributes specified by the attribute component 1330. In an example embodiment, the simulation component 1320 may construct one or more models of the geologic environment 1350, which may be relied on to simulate behavior of the geologic environment 1350 (e.g., responsive to one or more acts, whether natural or artificial). In the example of FIG. 13, the analysis/visualization component 1342 may allow for interaction with a model or model-based results (e.g., simulation results, etc.). As an example, output from the simulation component 1320 may be input to one or more other workflows, as indicated by the workflow component 1344.

As an example, the simulation component 1320 may include one or more features of a simulator such as the ECLIPSE™ reservoir simulator (available from Schlumberger Technology Corporation, Houston Tex.), the INTERSECT™ reservoir simulator (available from Schlumberger Technology Corporation, Houston Tex.), etc. As an example, a reservoir or reservoirs may be simulated with respect to one or more enhanced recovery techniques (e.g., consider a thermal process such as SAGD, fracturing, etc.).

In an example embodiment, the management components 1310 may include features of a commercially available framework such as the PETREL® seismic to simulation software framework (available from Schlumberger Technology Corporation, Houston, Tex.). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 1310 may include add-ons or plug-ins that operate according to specifications of a framework environment. For example, a commercially available framework environment marketed as the OCEAN® framework environment (available from Schlumberger Technology Corporation, Houston, Tex.) allows for integration of add-ons (or plug-ins) into a PETREL® framework workflow. The OCEAN® framework environment leverages .NET® tools (available from Microsoft Corporation, Redmond, Wash.) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 13 also shows an example of a framework 1370 that includes a model simulation layer 1380 along with a framework services layer 1390, a framework core layer 1395 and a modules layer 1375. The framework 1370 may include the commercially available OCEAN® framework where the model simulation layer 1380 is the commercially available PETREL® model-centric software package that may host OCEAN® framework applications. In an example embodiment, the PETREL® software may be considered a data-driven application. The PETREL® software can include a framework for model building and visualization. Such a model may include one or more grids.

The model simulation layer 1380 may provide domain objects 1382, act as a data source 1384, provide for rendering 1386 and provide for various user interfaces 1388. Rendering 1386 may provide a graphical environment in which applications can display their data while the user interfaces 1388 may provide a common look and feel for application user interface components.

In the example of FIG. 13, the domain objects 1382 can include entity objects, property objects and optionally other objects. Entity objects may be used to geometrically represent wells, surfaces, reservoirs, etc., while property objects may be used to provide property values as well as data versions and display parameters. For example, an entity object may represent a well where a property object provides log information as well as version information and display information (e.g., to display the well as part of a model).

In the example of FIG. 13, data may be stored in one or more data sources (or data stores, generally physical data storage devices), which may be at the same or different physical sites and accessible via one or more networks. The model simulation layer 1380 may be configured to model projects. As such, a particular project may be stored where stored project information may include inputs, models, results and cases. Thus, upon completion of a modeling session, a user may store a project. At a later time, the project can be accessed and restored, for example, using the model simulation layer 1380, which may allow for recreating instances of relevant domain objects.

In the example of FIG. 13, the geologic environment 1350 may include layers (e.g., stratification) that include a reservoir 1351 and that may be intersected by a fault 1353. As an example, the geologic environment 1350 may be outfitted with any of a variety of sensors, detectors, actuators, etc. For example, equipment 1352 may include communication circuitry to receive and to transmit information with respect to one or more networks 1355. Such information may include information associated with downhole equipment 1354, which may be equipment to acquire information, to assist with resource recovery, etc. Other equipment 1356 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 13 shows a satellite in communication with the network 1355 that may be configured for communications, noting that the satellite may additionally or alternatively include circuitry for imagery (e.g., spatial, spectral, temporal, radiometric, etc.).

FIG. 13 also shows the geologic environment 1350 as optionally including equipment 1357 and 1358 associated with a well that includes a substantially horizontal portion that may intersect with one or more fractures 1359. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 1357 and/or 1358 may include components, a system, systems, etc. for fracturing, seismic sensing, analysis of seismic data, assessment of one or more fractures, etc.

As mentioned, the system 1300 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

As an example, an analysis of data for a fractured system may be provided (e.g., as input) to one or more modules configured to perform a production evaluation workflow, which may include multiple processes. As an example, a workflow may be configured in a framework that provides for various processes, which may be implemented, for example, via execution of instructions in one or more modules.

As an example, a workflow may include a rate transient analysis (RTA), which may, for example, analyze so-called low-frequency production data and/or other production data. As an example, a RTA may include analysis of data for a fractured system where the data includes data less than an interaction time or time (e.g., for interactions between various fractures in the fractured system). As an example, an analysis may provide well drainage area and optionally other reservoir and well parameters, for example, permeability, skin, fracture half-length, and fracture conductivity.

As an example, a reservoir simulation workflow may receive production rates (e.g., daily, sporadic, etc.) as input to match flowing and average reservoir pressures in a multiple-well environment. Depending on data acquisition techniques, processes, etc., pressure data may be provided sporadically, may be sparse, etc. As an example, a history-matched reservoir model may enhance prediction of behavior performance of a reservoir and well(s) system. As an example, a framework such as the DECIDE!® framework (available from Schlumberger Technology Corporation, Houston, Tex.) may be implemented for data handling, history-matching, etc.

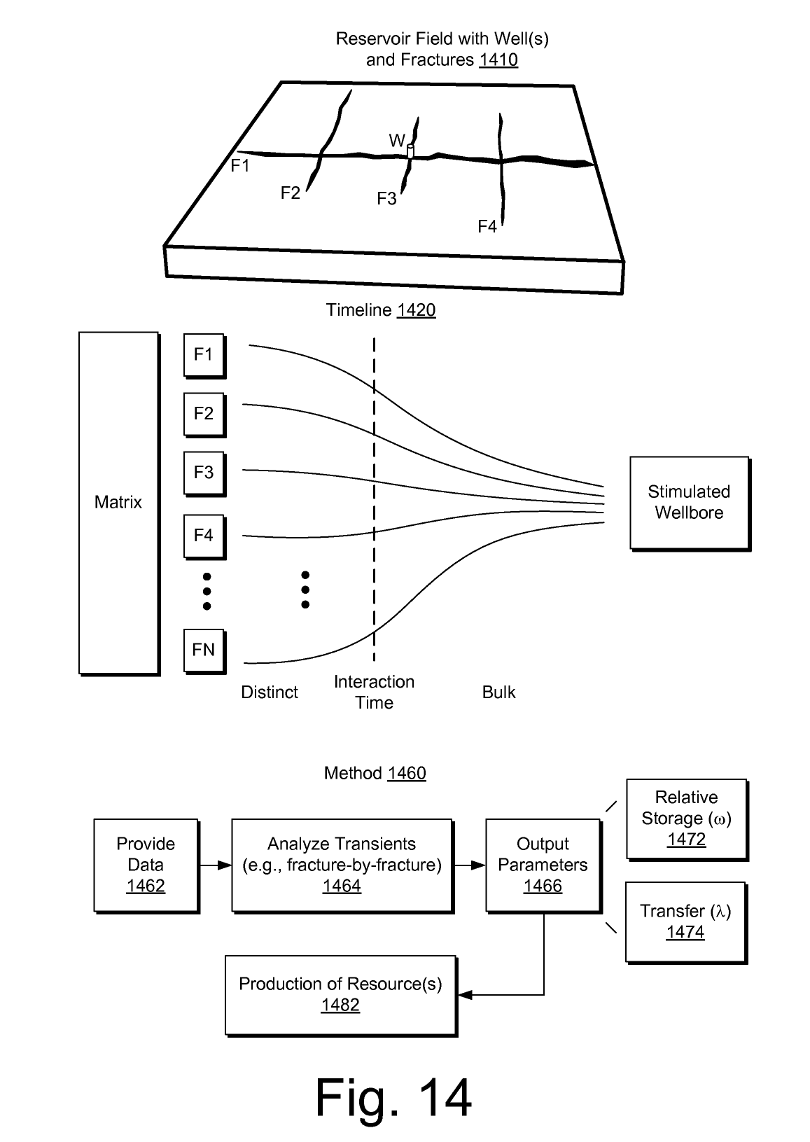

FIG. 14 shows an example of a field 1410 with well(s) and fractures where fluid or fluids may transfer from a matrix to the fractures. As indicated in a timeline, an interaction time or times exist where interactions or interference between fluid or fluids from fractures to a well occur that, as explained, may be seen in data such that characteristics of each fracture in the data become less distinct and more bulk (e.g., as for data from a stimulated wellbore).

FIG. 14 also shows an example of a method 1460 that includes a provision block 1462 for providing data, an analysis block 1464 for analyzing at least a portion of the provided data, an output block 1466 for outputting one or more parameter values based at least in part on the analysis of the analysis block 1464 and a production block 1482 for producing one or more resources via a well in a fractured system (see, e.g., the field 1410). As to the parameters, consider, for example, a block 1472 for outputting one or more relative storage parameter values and a block 1474 for outputting a transfer parameter values.

As an example, a method can include bilinear and linear flow regime production diagnostic analyses to obtain initial estimates of individual reservoir properties and well completion effectiveness. As an example, such a method may further include providing one or more initial parameter estimates to a trilinear pressure-transient solver, for example, implemented using a nonlinear numerical inversion algorithm (e.g., Levenberg-Marquardt, etc.). As an example, a nonlinear regression analysis may allow for imposition of optional constraints on one or more variable parameter values. An inversion technique may provide refined values for one or more parameters (e.g., as output from a flow regime production diagnostic analysis). In the example method 1460 of FIG. 14, the analysis block 1464 may optionally include production diagnostic analyses and a nonlinear regression analysis (e.g., for performing an inversion).

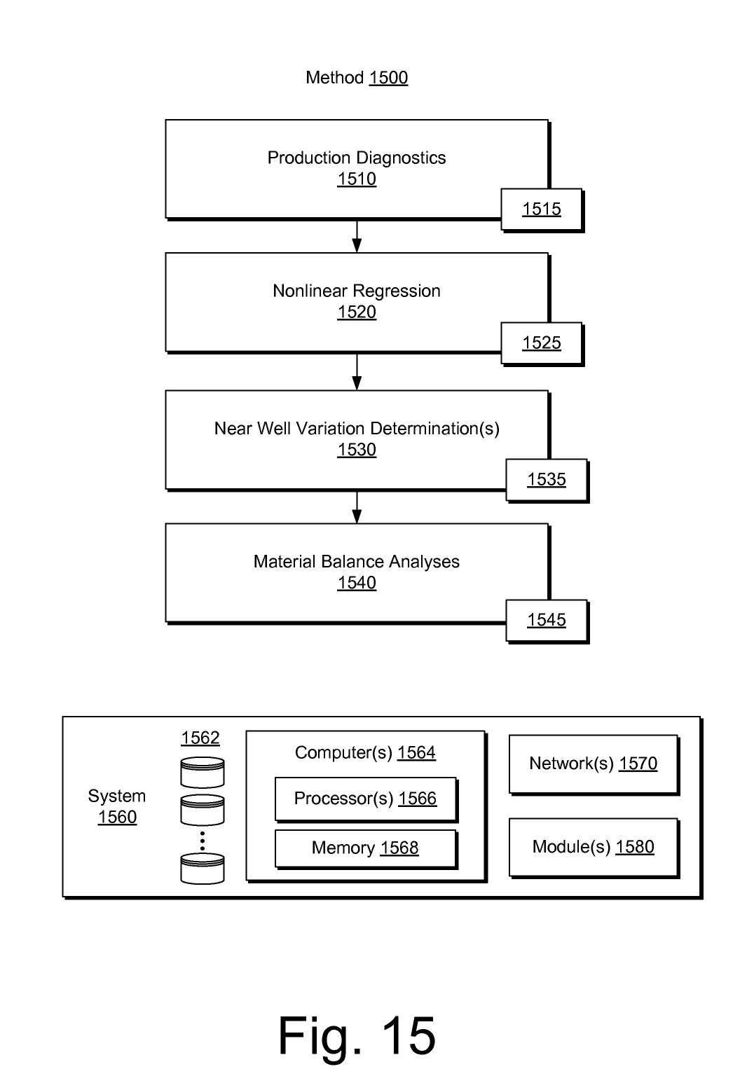

FIG. 15 shows an example of a method 1500 that includes a production diagnostics block 1510, a nonlinear regression block 1520, a near well variation determination(s) block 1530 and a material balance analyses block 1540. Also shown are computer-readable media (CRM) blocks 1515, 1525, 1535 and 1545. The CRM blocks may include instructions stored in a computer-readable medium such as a memory device. Such instructions may be executable by one or more processors (e.g., cores) to instruct a computing system to perform various actions of the method 1500. While various CRM blocks are shown, a single block may include instructions of each of these blocks. As an example, various blocks of the example of FIG. 15 may be provided as plug-ins, modules, code, etc., for a framework such as the OCEAN® framework. As an example, one or more of the blocks of FIG. 15 may be plug-ins for a PETREL® framework.

FIG. 15 also shows an example of a system 1560 that includes one or more information storage devices 1552, one or more computers 1554, one or more networks 1560 and one or more modules 1570. As to the one or more computers 1554, each computer may include one or more processors (e.g., or processing cores) 1556 and memory 1558 for storing instructions (e.g., modules), for example, executable by at least one of the one or more processors. As an example, a computer may include one or more network interfaces (e.g., wired or wireless), one or more graphics cards, a display interface (e.g., wired or wireless), etc.

In the example of FIG. 15, the one or more memory storage devices 1552 may store production data, fracture data, well data, etc., for a geologic environment. As an example, a computer may include a network interface for accessing data stored in one or more of the storage devices 1552 via a network. In turn, the computer may process the accessed data via instructions, which may be in the form of one or more modules.

As an example, a system for characterizing a field that includes a well and hydraulic fractures may include a processor; memory accessible by the processor; and instructions modules stored in the memory and executable by the processor where the instructions modules include a production diaganostics instructions module associated with production of fluid from the field at least in part via the hydraulic fractures, a nonlinear regression instructions module, a near well variation determination instructions module, and a material balance analysis instructions module. As an example, such a system may include a production control instructions module, a fracture scheme design instructions module, etc.

As an example, a method can include: production diagnostics for bilinear and linear flow behavior of multiply-fractured horizontal wells in oil or gas reservoirs; a nonlinear regression analysis procedure coupled with a trilinear pressure-transient well performance model for history-matching well performance (e.g., as a rate or pressure-transient analysis, with or without constrained regularization); computational analyses for determining near well relative or effective permeability variations with respect to production time; and material balance analyses for evaluating variation in reservoir pore pressure and average reservoir fluid saturations with respect to time.

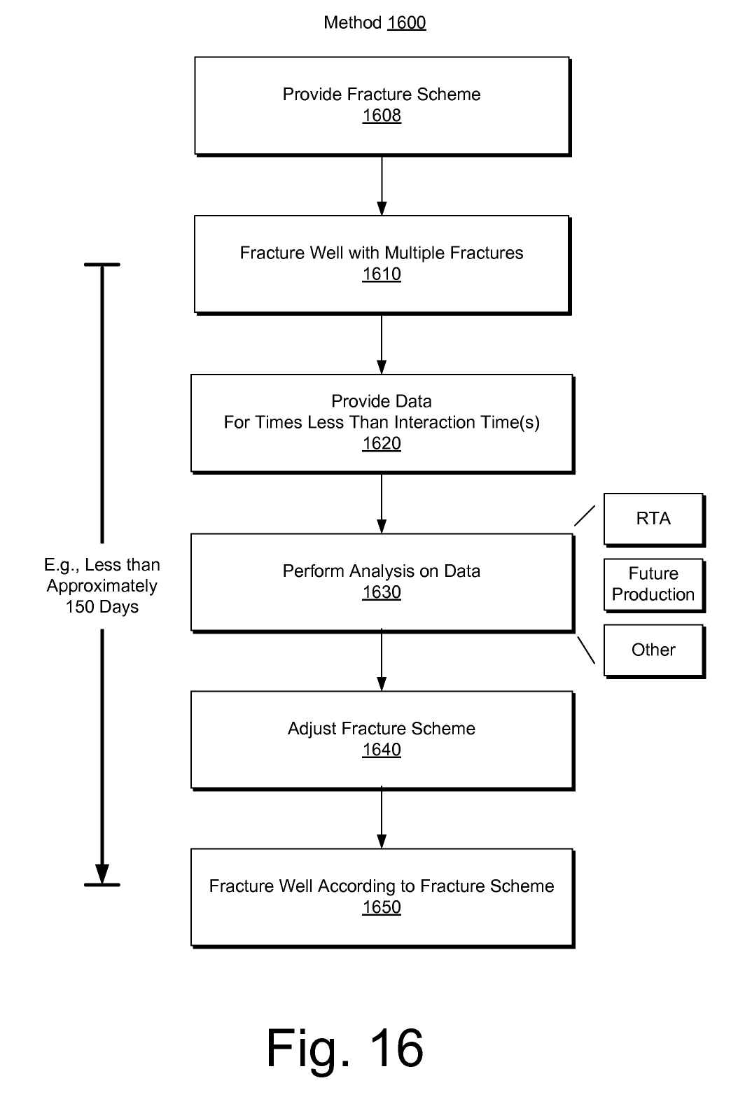

FIG. 16 shows an example of a method 1600 that includes a provision block 1608 for providing a fracture scheme, a fracture block 1610 for fracturing a well with multiple fractures (e.g., according to the fracture scheme), a provision block 1620 for providing data (e.g., for, at least, times less than an interaction time or times), a performance block 1630 for performing an analysis on the data (e.g., including analyzing at least a portion of the data for times less than an interaction time for the multiple fractures), an adjustment block 1640 for adjusting a fracture scheme (e.g., optionally as implemented in the block 1610), and a fracture block 1650 for fracturing a well according to the adjusted fracture scheme. As an example, the method 1600 of FIG. 16 may be performed in less than about 150 days or another time, for example, depending on one or more interaction times (see, e.g., the timeline 1420 of FIG. 14). For example, a method may include fracturing a well based at least in part on an adjusted fracture scheme where the fracturing occurs prior to an interaction time associated with multiple fractures, which may be existing fractures.

As an example, a method can include rate transient analysis, pressure forecasting analysis or both. As an example, one or more modules may provide for rate transient analysis for production performance of well and pressure forecasting analysis (e.g., after a history match process) to predict future recovery from a well.

As an example, a method can include providing data for a field that includes fractures and a well; analyzing at least a portion of the data for times less than an interaction time; and outputting one or more values for a parameter that characterizes storage of a fluid in the field and one or more values for a parameter that characterizes transfer of the fluid in the field. Such a method can include diagnostics analyzing and nonlinear regression analyzing. As an example, a method can include analyzing with respect to a trilinear model.

As an example, an interaction time may be a time less than approximately 150 days, a time less than approximately 50 days, or a time less than approximately 25 days. As an example, times less than an interaction time may provide data indicative of distinct fractures. As an example, times greater than an interaction time may provide data indicative of interacting fractures.

As an example, a method can include determining an interaction time. As an example, such a method may include using a correlation for estimating the interaction time as a time to cessation of an initial fracture linear flow regime.

As an example, a field may include shale. As an example, a field may include greater than about 50 fractures. As an example, a field can include material having bulk permeability values in a nano-Darcy range.

As an example, a method can include defining a stimulated reservoir volume based on lengths of fractures, formation thickness, number of fractures, and spacing between adjacent fractures. In such an example, the fractures may be vertical fractures.

As an example, a system for characterizing a field that includes fractures can include a processor; memory; and instructions modules stored in the memory where the instructions modules include: a production diaganostics instructions module, a nonlinear regression instructions module, a near well variation determination instructions module, and a material balance analysis instructions module. As an example, such a system may include a production control instructions module (e.g., for controlling production of fluid from a reservoir in the field via one or more wells). As an example, a system may include a fracture scheme design instrcutions module.

As an example, a method can include providing a fracture scheme; fracturing a well with multiple fractures according to the fracture scheme; providing data from the well; performing an analysis on the data; and adjusting the fracture scheme based at least in part on the analysis of the data. Such a method may include fracturing the well or another well according to the adjusted fracture scheme.

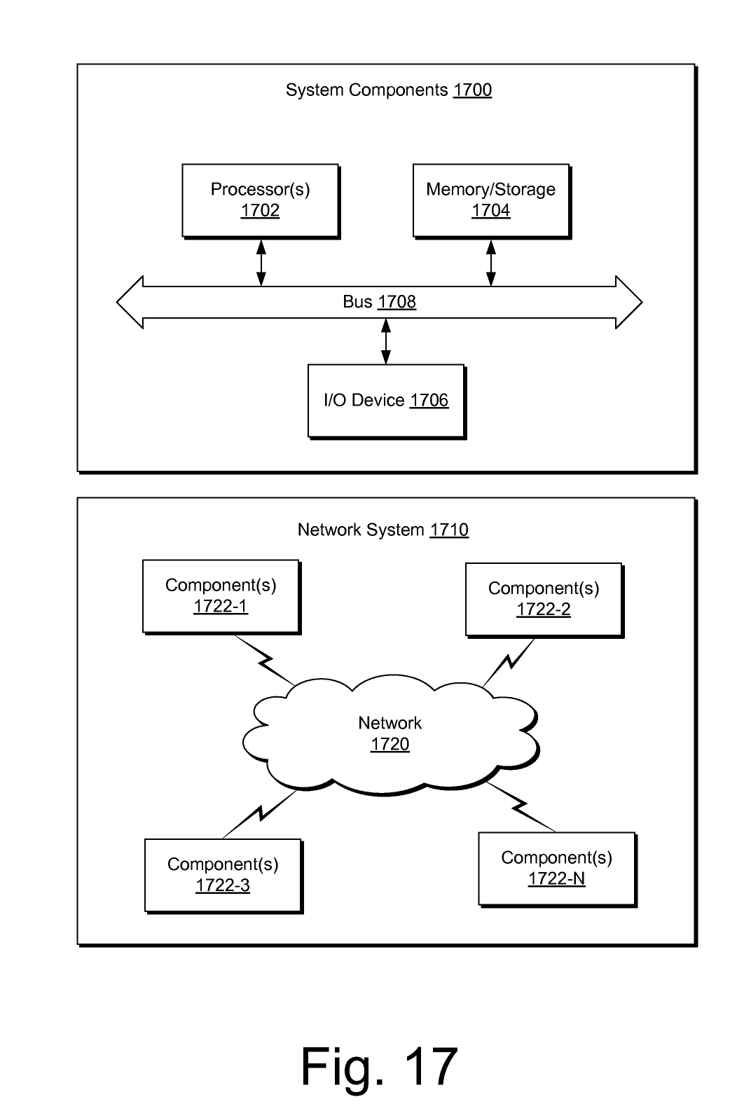

FIG. 17 shows components of an example of a computing system 1700 and an example of a networked system 1710. The system 1700 includes one or more processors 1702, memory and/or storage components 1704, one or more input and/or output devices 1706 and a bus 1708. In an example embodiment, instructions may be stored in one or more computer-readable media (e.g., memory/storage components 1704). Such instructions may be read by one or more processors (e.g., the processor(s) 1702) via a communication bus (e.g., the bus 1708), which may be wired or wireless. The one or more processors may execute such instructions to implement (wholly or in part) one or more attributes (e.g., as part of a method). A user may view output from and interact with a process via an I/O device (e.g., the device 1706). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 1710. The network system 1610 includes components 1722-1, 1722-2, 1722-3, . . . 1722-N. For example, the components 1722-1 may include the processor(s) 1702 while the component(s) 1722-3 may include memory accessible by the processor(s) 1702. Further, the component(s) 1702-2 may include an I/O device for display and optionally interaction with a method. The network may be or include the Internet, an intranet, a cellular network, a satellite network, etc.

Although only a few example embodiments have been described in detail above, those skilled in the art will readily appreciate that many modifications are possible in the example embodiments. Accordingly, such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words “means for” together with an associated function.

As such, although the preceding description has been described herein with reference to particular means, materials, and embodiments, it is not intended to be limited to the particulars disclosed herein; rather, it extends to all functionally equivalent structures, methods, and uses, such as are within the scope of the appended claims.

### NOMENCLATURE

a₁, a₂ Coefficients of linear equation
B Oil formation volume factor, rb/STB
C_{fD} Dimensionless fracture conductivity
cₜ Total system compressibility, 1/psia
D Distance between outermost fractures of multiply-fractured horizontal well, ft
d_{f} Distance between adjacent fractures, ft
f Superposition time function
h Reservoir net pay thickness, ft
k Reservoir effective permeability, md
k_{f} Permeability of fissures in dual porosity system, md
k_{f}w Fracture conductivity, md-ft
kᵢ Inner region (SRV) effective permeability, md (equates to k_{y} in this analysis)
kₘ Matrix permeability in dual porosity system, md
kₒ Outer region (outside of SRV) effective permeability, md (equates to a kₓ in this analysis)
kₓ Directional effective permeability for flow in the X direction (normal to horizontal wellbore), md
k_{y} Directional effective permeability for flow in the Y direction (normal to fracture plane), md
m Slope of Cartesian graph of pressure-transient behavior versus linear flow superposition time
n_{f} Number of vertical fractures intersecting the horizontal well
P Pressure, psia
P_{b} Base (lower limit) pressure of integration, psia
Pᵢ Initial reservoir pore pressure, psia
Pₚ Real gas pseudopressure function, psia2/cp
P_{sc} Standard condition pressure, psia
P_{wD} Dimensionless wellbore pressure
P_{wf} Sandface flowing pressure, psia
q Oil flow rate, STB/D
q_{g} Gas flow rate, Mscf/D
r_{w} Wellbore radius, ft
S_{c} Converging flow steady state skin effect
t Time, hrs
T Reservoir temperature, ° R
tₐ Real gas pseudotime function, hrs-psia/cp
t_{D} Dimensionless time
t_{Delf} Dimensionless time at end of linear flow regime
t_{Dslf} Dimensionless time as start of linear flow regime
t_{elf} Time to end of linear flow, hrs
T_{sc} Standard condition temperature, ° R
w Fracture width, in
X_{D} Dimensionless distance of investigation into the system, from the fracture face
X_{f} Fracture half-length, ft
Yₑ Drainage area extent of each fracture in Y direction, ft
Z Gas law deviation (supercompressibility) factor
λ Dual porosity reservoir crossflow parameter
μ Oil viscosity, cp
μ_{g} Gas viscosity
μ̅_̅{̅g̅}̅c̅ₜ̅ Mean value gas viscosity-total system compressibility product
σ Dual porosity reservoir matrix block shape factor
η Reservoir hydraulic diffusivity, md-psia/cp
ω Dual porosity reservoir storativity ratio

### Functions Description

Γ Gamma function
erfc Complimentary error function
lIn Natural logarithm
log Base 10 logarithm

What is claimed is:

1. A method comprising:
providing data for a field that comprises fractures and a well;
analyzing at least a portion of the data for times less than an interaction time; and
outputting one or more values for a parameter that characterizes storage of a fluid in the field and one or more values for a parameter that characterizes transfer of the fluid in the field.

2. The method of claim 1 wherein the analyzing comprises diagnostics analyzing and nonlinear regression analyzing.

3. The method of claim 1 wherein the analyzing comprises analyzing with respect to a trilinear model.

4. The method of claim 1 wherein the interaction time comprises a time less than approximately 150 days.

5. The method of claim 1 wherein the interaction time comprises a time less than approximately 50 days.

6. The method of claim 1 wherein the interaction time comprises a time less than approximately 25 days.

7. The method of claim 1 wherein times less than the interaction time provide data indicative of distinct fractures.

8. The method of claim 1 wherein times greater than the interaction time provide data indicative of interacting fractures.

9. The method of claim 1 wherein the analyzing comprises determining the interaction time.

10. The method of claim 9 wherein the determining comprises using a correlation for estimating the interaction time as a time to cessation of an initial fracture linear flow regime.

11. The method of claim 1 wherein the field comprises shale.

12. The method of claim 1 wherein the field comprises greater than 50 fractures.

13. The method of claim 1 wherein the field comprises material having bulk permeability values in a nano-Darcy range.

14. The method of claim 1 comprising defining a stimulated reservoir volume based on lengths of fractures, formation thickness, number of fractures, and spacing between adjacent fractures.

15. The method of claim 14 wherein the fractures comprise vertical fractures.

16. A system for characterizing a field that comprises a well and hydraulic fractures, the system comprising:
a processor;
memory accessible by the processor; and
instructions modules stored in the memory and executable by the processor wherein the instructions modules comprise
a production diaganostics instructions module associated with production of fluid from the field at least in part via the hydraulic fractures,
a nonlinear regression instructions module,
a near well variation determination instructions module, and
a material balance analysis instructions module.

17. The system of claim 16 comprising a production control instructions module.

18. The system of claim 16 comprising a fracture scheme design instructions module.

19. A method comprising:
providing a fracture scheme;
fracturing a well with multiple fractures according to the fracture scheme;
providing data from the well;
performing an analysis on the data wherein the performing comprises analyzing at least a portion of the data for times less than an interaction time for the multiple fractures; and
adjusting the fracture scheme based at least in part on the analysis of the data.

20. The method of claim 19 comprising fracturing the well or another well according to the adjusted fracture scheme.
